(19) United States
(12) Patent Application Publication
(10) Pub. No.: US 2007/0021189 A1
(43) Pub. Date: Jan. 25, 2007

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE Corp.

(21) Appl. No.: 11/472,540

(22) Filed: Jun. 22, 2006

(30) Foreign Application Priority Data
Jun. 24, 2005 (JP) 2005-185444

(51) Int. Cl. A63F 13/00

(52) U.S. Cl. 463/20

(57) ABSTRACT

There is provided a gaming machine which may perform a second variable display of symbols in one direction, while the symbols having been displayed in a stationary mode after a first variable display in another direction. Therefore, the player's expectation may be enhanced and a variety of game modes can be provided.

### CROSS REFERENCE TO RELATED APPLICATIONS

This application is based upon and claims the benefits of priorities from Japanese Patent Application No. 2005-185444 filed on Jun. 24, 2005, the entire contents of which are incorporated herein by reference.

### FIELD OF THE INVENTION

The present invention relates to a gaming machine such as a slot machine to award a benefit to a player based on a combination of symbols being displayed in a stationary mode after a plurality of groups of symbols are displayed variably in respective groups of display areas. More specifically, it relates to a gaming machine which displays the combination of symbols, after displaying a plurality of groups of symbols variably in respective groups of display areas, in a stationary mode and resumes variable display in such a manner that the groups of symbols are regrouped into different groups of symbols and displayed variably in different respective groups of symbols. Therefore, the player may have more expectation to the game and the game can have more variety.

### RELATED ART

Conventionally, a gaming machine such as a slot machine and a pachi-slot machine which repeats variable display and stationary display of symbols displays columns of symbols variably in predetermined areas as a game is started upon insertion of a game medium such as a medal, and stops such variable display to display the columns of symbols in a stationary mode after a predetermined period of time from the start of the variable display. The gaming machine is so configured that it may provide a benefit (for example, pay out game media) if the combination of symbols displayed in a stationary mode matches a predetermined winning combination.

Here, a device that conducts the variable display and stationary display of the symbols in the slot machine or the pachi-slot machine is not used just as means for notifying directly a lottery result, but is also used as effect display means for achieving improvement of entertainment ability of the gaming machine, which cannot be realized by notifying directly the combination of symbols.

However, the slot machine or the pachi-slot machine repeats basically such variable display and stationary display of the columns of symbols, which look like the same processes in each cycle, even though the columns of symbols being displayed in a stationary mode may differ in each cycle. Therefore, the player who plays the game for a long period of time may feel that the game is monotonous, and get tired of the game.

Then, there has been proposed a gaming machine that performs a variable mode of symbols in a different variable mode if a predetermined condition is satisfied. For example, in Japanese Unexamined Patent Application Publication No. 2005-40500, there is disclosed a gaming machine which performs a variable mode of symbols such that a symbol “7” is once stopped (i.e., the reel having the symbol “7” is once stopped) and displayed in a stationary mode at a position off a pay line L, and then the symbol “7” is moved smoothly to a position on the pay line L if “re-spin” is selected as a variable mode of symbols, or such that the symbol “7” is once stopped and displayed in a stationary mode at a position off the pay line L, and then the symbol “7” is moved little by little (or nudged) to the position on the pay line L if “nudge” is selected as a variable display manner of the symbols.

However, the gaming machine disclosed in the Japanese Unexamined Patent Application Publication No. 2005-40500 performs variable display in such a manner that the reel is rotated again after the reel is stopped once so that the game may have more variety, but the number of kinds of symbols to be variably displayed on each of a plurality of disposed reels is predetermined and fixed and the direction of movement (in the variable display) of symbols is limited to one direction (e.g., from the top to the bottom) or an opposite direction to the one direction (e.g., from the bottom to the top). Therefore, it is possible to change the direction and the speed of variable movement of the symbols, but the variation thereof is limited such that the player can expect such direction and speed and the variation of the game is not necessarily enough. Also, the player may lose the player's expectation to win the winning combination if similar manners in the variable mode of symbols are repeatedly performed.

### SUMMARY OF THE INVENTION

According to the present invention, it is possible to display symbols variably with a variety of variable mode that provides a player with a visually fresh feeling such that the player may not be able to predict the result. Therefore, it is possible to provide a gaming machine which performs a variety of game so as to promote the player's expectation toward the game.

There is provided a gaming machine comprising: a display device for displaying a plurality of symbols in a variable mode and a stationary mode; and a control device for controlling the display device. The display device comprises a plurality of display areas where the plurality of symbols are displayed. The plurality of display areas are divided into groups of a first kind and groups of a second kind in an overlapping manner, the groups of the first kind being aligned with each other along a first direction, the groups of the second kind being aligned with each other along a second direction. The control device controls the display device to display the plurality of symbols variably in the groups of display areas of the first kind such that the symbols move in a first direction within each group of display areas of the first kind during a first variable display and the control device controls the display device to display a first stationary combination in a stationary mode after the first variable display. The control device controls the display device to display variably at least one of the symbols of the first stationary combination in the groups of display areas of the second kind such that the symbols move in a second direction within each group of display areas of the second kind during a second variable display and the control device controls the display device to display a second stationary combination in a stationary mode after the second variable display. Here, a benefit is awarded based on a first winning combination to be included in the first stationary combination or based on a second winning combination to be included in the second stationary combination.

Further features of the present invention, its nature, and various advantages will be more apparent from the accompanying drawings and the following description of the preferred embodiment.

### BRIEF DESCRIPTION OF THE DRAWINGS

FIG. 1 is a perspective view of a slot machine according to a first embodiment.

FIG. 2A is a front view showing a left reel, a center reel and a right reel, which correspond to first variable display means of the slot machine according to the first embodiment.

FIG. 2B is a front view showing a top reel, a middle reel and a bottom reel, which correspond to second variable display means of the slot machine according to the first embodiment.

FIG. 3 is a front view showing an operation table of the slot machine according to the first embodiment.

FIG. 4 shows schematically columns of symbols, which are variably displayed on respective reels.

FIG. 5 is a schematic diagram of a control system of the slot machine according to the first embodiment.

FIG. 6 is a block diagram showing schematically a liquid crystal driving circuit of a liquid crystal display.

FIG. 7 is a drawing showing each storage area of ROM of the slot machine according to the first embodiment.

FIG. 8 shows a lottery table of winning combinations.

FIG. 9 shows a payout table of winning combinations and payout amounts for respective winning combinations.

FIGS. 10A through 10C show symbol effect lottery tables for selecting a variable mode of symbols in first and second variable stages.

FIG. 11 is a flow chart of a main process program of the slot machine according to the first embodiment.

FIG. 12 is a flow chart of a start acceptance process program of the slot machine according to the first embodiment.

FIG. 13 is a flow chart of a lottery process program of the slot machine according to the first embodiment.

FIG. 14 is a flow chart of a base game process program of the slot machine according to the first embodiment.

FIG. 15 is a schematic drawing showing an example of a variable mode of symbols in the second variable stage of the slot machine according to the first embodiment.

FIG. 16 is a schematic drawing showing another example of a variable mode of symbols in the second variable stage of the slot machine according to the first embodiment.

FIG. 17 is a schematic drawing showing yet another example of a variable mode of symbols in the second variable stage of the slot machine according to the first embodiment.

FIG. 18 is a schematic drawing showing yet another example of a variable mode of symbols in the second variable stage of the slot machine according to the first embodiment.

FIG. 19 is a schematic drawing showing yet another example of a variable mode of symbols in the second variable stage of the slot machine according to the first embodiment.

FIG. 20 is a schematic drawing showing yet another example of a variable mode of symbols in the second variable stage of the slot machine according to the first embodiment.

FIG. 21 is a schematic drawing showing yet another example of a variable mode of symbols in the second variable stage of the slot machine according to the first embodiment.

FIG. 22 is a schematic drawing showing yet another example of a variable mode of symbols in the second variable stage of the slot machine according to the first embodiment.

FIGS. 23A through 23C show symbol effect lottery tables for selecting a variable mode of symbols in the first and second variable stages according to a second embodiment.

FIG. 24 is a flow chart of a base game process program of the slot machine according to the second embodiment.

FIG. 25 is a schematic drawing showing an example of a variable mode in the second variable stage of the slot machine according to the second embodiment.

FIG. 26 is a schematic drawing showing another example of a variable mode of symbols in the second variable stage of the slot machine according to the second embodiment.

### DESCRIPTION OF THE PREFERRED EMBODIMENT

In a gaming machine of the present invention, slot machines of first and second embodiments, which exemplify the present invention, will be explained below in reference to the drawings.

### First Embodiment

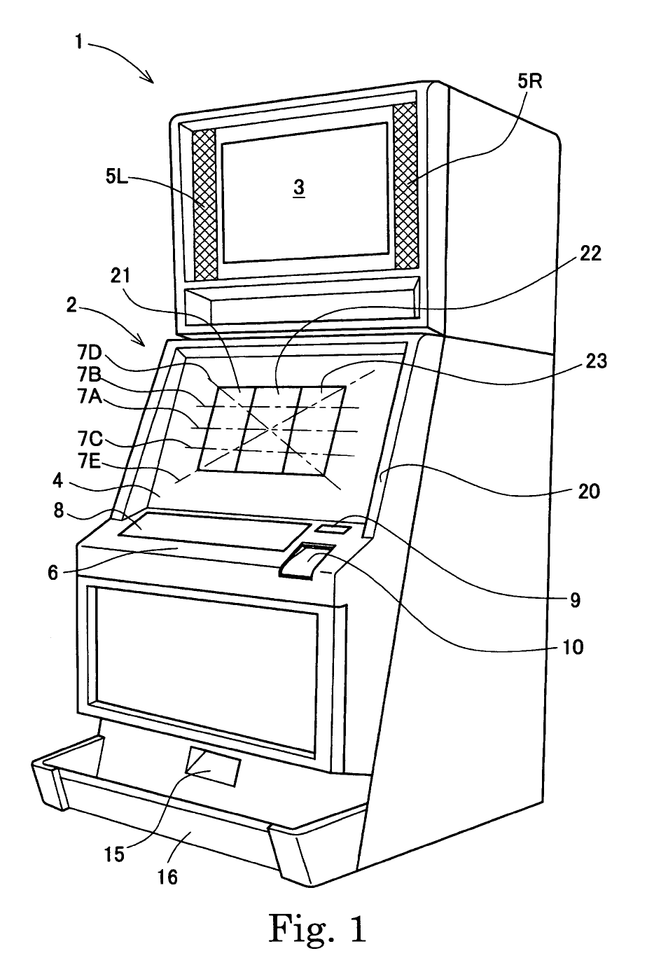

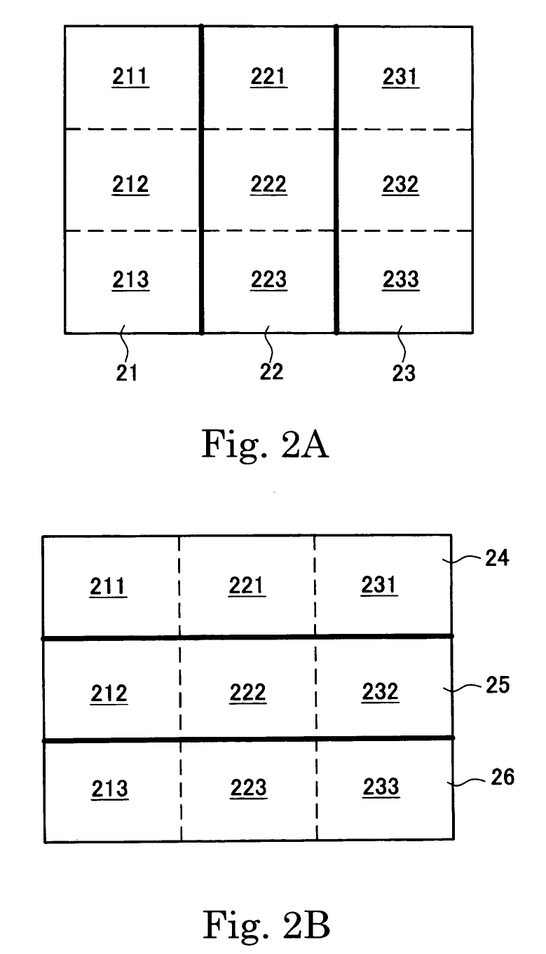

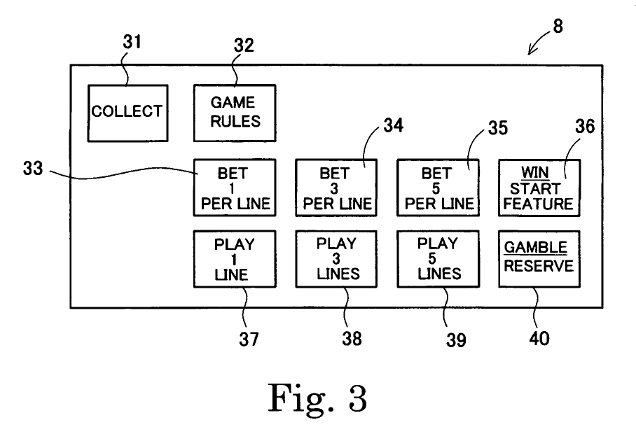

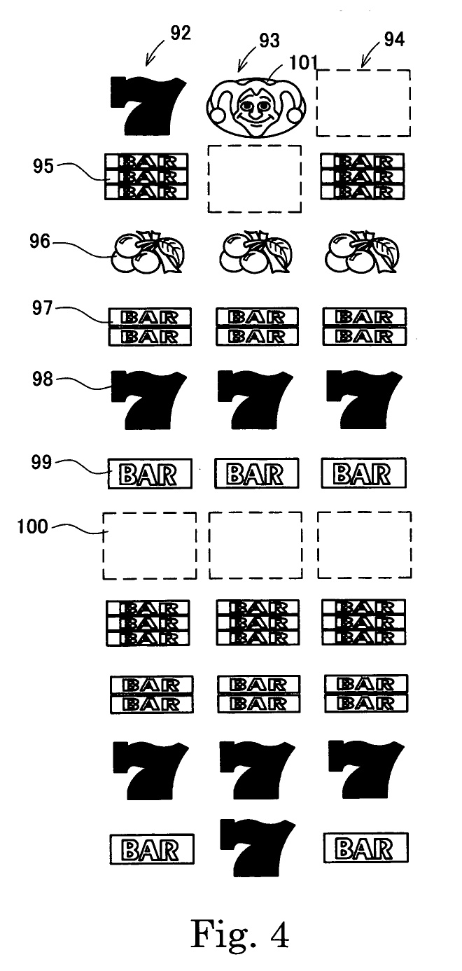

Here, a slot machine of a first embodiment is a so-called video slot machine which comprises an image display device such as a liquid crystal display and performs a game by display various symbol images variably and statically (or quiescently) on an image display device. Here, the variable display and the static (or stationary) display may be to display a plurality of symbols (of the same kind or different kinds) on a screen (including a so-called display window) of the display device one after another, and to display one or more symbols (of the same kind or different kinds) statically (or in a stationary mode). By way of example, the variable display may include displaying a plurality of symbols (of the same kind or different kinds) on the screen, which is fixed to the display device, in such a manner as the plurality of symbols are scrolled from the top to the bottom (or from the bottom to the top), or from the right to the left (or from the left to the right), or in other directions. And the stationary display (or stop-display), for example, may include stopping such movement of the symbols being displayed variably (or being scrolled) and displaying the symbols (or some of the symbols) in a stationary mode (i.e., the symbols not to be moved from the top to the bottom or the like). The general configuration of the slot machine 1 of the first embodiment is explain below in reference to FIGS. 1 through 3. FIG. 1 is a perspective view showing an outer appearance of the slot machine of the first embodiment. FIG. 2A is a front view showing a left reel 21, a center reel 22, and a right reel 23 as first variable display means of the slot machine according to the first embodiment. FIG. 2B is a front view showing a top (or upper) reel 25, a middle reel 25, and a bottom (or lower) reel 26 as second variable display means of the slot machine according to the first embodiment. FIG. 3 is a front view showing an operation panel 8 of the slot machine according to the first embodiment.

In FIG. 1, the slot machine 1 comprises a cabinet which constitutes a general outer shape. On the upper front part of the cabinet 2, an upper liquid crystal display 3 is disposed. On a machine front panel 20 disposed in the center front part of the cabinet 2, a lower liquid display 4 is disposed. Here, commercially available general-purpose liquid crystal displays are utilized for the upper liquid crystal display 3 and the lower liquid crystal display 4.

Further, a pair of speakers 5L, 5R are provided on right and left sides of the upper liquid crystal display 3 and output predetermined BGM (background music), voice, effect sounds, and so on based on a game state of the slot machine 1. Further, under the lower liquid crystal display 4, an operation table 6, which projects frontward, is disposed. On the operation table 6, there are provided from the left side an operation panel 8 where various buttons are provided, a coin insertion part 9 where a game medium such as a coin and the like is inserted, and a bill insertion part 10 where a paper money is inserted.

On the upper liquid crystal display 3, information about the game such as a gaming method, a kind and payout amount of each winning combination (prize-winning combination), various kinds of effects about the game, and so on is displayed.

On the lower liquid crystal display 4, three columns of video reels (left reel 21, center reel 22, and right reel 23) are realized by being displayed in the center of the lower liquid crystal display 4 as well as a credit number the player owns and various kinds of effect images are displayed. Here, the left reel 21, the center reel 22, and the right reel 23 correspond to first variable display means.

And various kinds of symbols to be described later are displayed variably such that they are scrolled from the top to the bottom in the left reel 21, the center reel 22, and the right reel 23, respectively. After a predetermined period of time, the symbols come to a halt (are stopped) and are displayed in a predetermined combination of symbols.

Also, when a predetermined condition is satisfied in the slot machine 1 according to the first embodiment, three rows of video reels (top reel 24, middle reel 25, and bottom reel 26) are displayed variably in replacement of the left reel 21, the center reel 22, and the right reel 23 such that the symbols having been stopped and displayed in the left reel 21, the center reel 22, and right reel 23, respectively, are displayed variably so as to be moved in a different direction subsequently. Here, the top reel 24, the middle reel 25, and the bottom reel 26 correspond to second variable display means.

Further, various kinds of symbols to be described later are displayed variably in the top reel 24, the middle reel 25, and the bottom reel 26, respectively, such that the symbols are scrolled from the left to the right or from the right to the left. And a predetermined combination of symbols come to a halt (are stopped) and are displayed in a stationary mode after a predetermined period of time.

Further, the slot machine 1 according to the first embodiment is a so-called video slot machine in which a slot game (the game comprises a base game and a bonus game as two kinds of game modes) is conducted with various video reels such as the left reel 21, the center reel 22 and right reel 23, or the top reel 24, the middle reel 25 and the bottom reel 26 being displayed on the lower liquid crystal display 4. Here, in the slot game (base game and bonus game) of the first embodiment, three symbols are displayed in the left reel 21, the middle reel 22 and the right reel 23, respectively, or the top reel 24, the middle reel 25 and the bottom reel 26, respectively, such that nine symbols in total are displayed.

More specifically, as shown in FIG. 2A, the left reel 21, the center reel 22 and the right reel 23 are divided into three areas as described below. The left reel 21 is composed of a first stationary display area 211, a second stationary display area 212 and a third stationary display area 213. The center reel 22 is composed of a fourth stationary display area 221, a fifth stationary display area 222 and a sixth stationary display area 223. The right reel 23 is composed of a seventh stationary display area 231, a eighth stationary display area 232 and a ninth stationary display area 233. And predetermined kinds of symbols are stopped and displayed in the stationary display areas 211 through 213, 221 through 223, and 231 through 233, respectively, based on the lottery result to be described later.

Subsequently, as shown in FIG. 2B, the top reel 24, the middle reel 25 and the bottom reel 26 display symbols variably in a different direction when a predetermined condition is satisfied after displaying symbols variably with the left reel 21, the center reel 22 and the right reel 23. The top reel 24 is composed of the first stationary display area 211, the fourth stationary display area 221 and the seventh stationary display area 231. The middle reel 25 is composed of the second stationary display area 212, the fifth stationary display area 222 and the eighth stationary display area 232. The bottom reel 26 is composed of the third stationary display area 213, the sixth stationary display area 223 and the ninth stationary display area 233. And predetermined kinds of symbols are stopped and displayed in the stationary display areas 211 through 213, 221 through 223, and 231 through 233, respectively, based on the lottery result to be described later.

In the slot game (base game and bonus game), there are five pay lines to tie one of the stationary display areas 211 through 213, one of the stationary display areas 221 through 223, and one of the stationary display areas 231 through 233. If each pay line is activated, a payout is paid out to the player when predetermined symbols are stopped and displayed as they are aligned in a predetermined combination along the activated pay line so as to form a winning combination. Here, each pay line is explained.

There are provided a center line 7A, a top line 7B and a bottom line 7C in the horizontal direction; and a cross-down line 7D and a cross-up line 7E in respective diagonal directions (refer to FIG. 1). The center line 7A is formed by tying the second stationary area 212, the fifth stationary area 222 and the eighth stationary area 232. The top line 7B is formed by tying the first stationary area 211, the fourth stationary area 221 and the seventh stationary area 231. The bottom line 7C is formed by tying the third stationary area 213, the sixth stationary area 223 and the ninth stationary area 233. The cross-down line 7D is formed by tying the first stationary area 211, the fifth stationary area 222 and the ninth stationary area 233. The cross-up line 7E is formed by tying the third stationary area 213, the fifth stationary area 222 and the seventh stationary area 231.

Here, a pay line among the above five pay lines that is activated by each operation button to be described later (PLAY 1 LINE button 37, PLAY 3 LINES button 38, and PLAY 5 LINES button 39) is referred to as an “activated pay line”.

Further, various kinds of operation buttons are disposed on the operation panel 8 provided on the operation table 6. Each operation button is concretely explained in reference to FIG. 3. In an upper row on the operation panel 8, a COLLECT button 31 and a GAME RULES button 32 are provided from the left side. And In a middle row, a BET 1 PER LINE button 33, a BET 3 PER LINE button 34, a BET 5 PER LINE button 35, a WIN START FEATURE button 36 are provided from the leftmost side. In a lower row, a PLAY 1 LINE button 37, a PLAY 3 LINES button 38, a PLAY 5 LINES button 39 and a GAMBLE RESERVE button 40 are provided from the leftmost side.

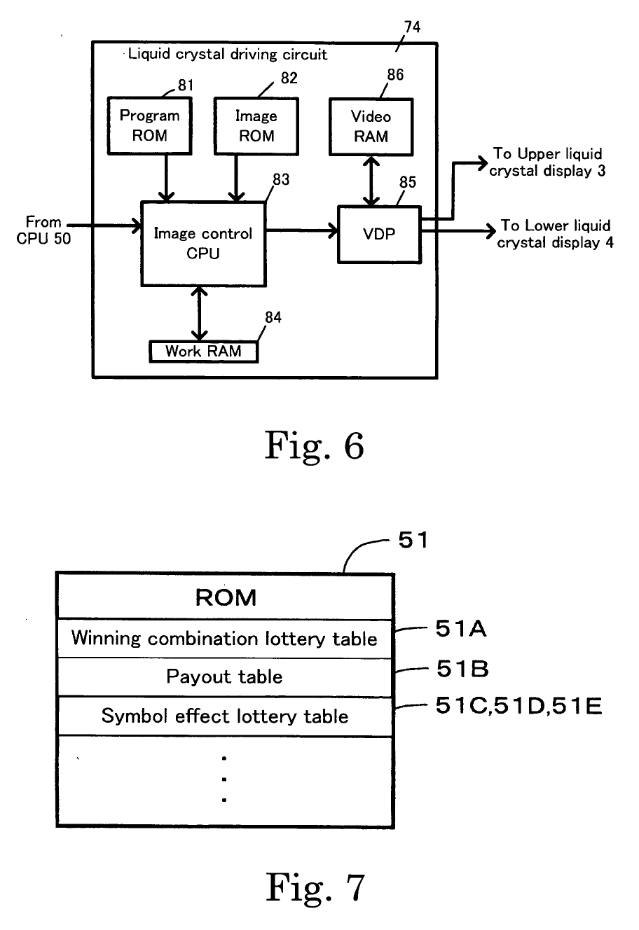

Here, the COLLECT button 31 is usually depressed when the game ends such that the equivalent number of coins to the credit number having been obtained during the games are paid out in a coin receiving part 16 from a coin payout opening 15 to be described later via a hopper (not shown) disposed inside the slot machine 1. And, a COLLECT switch 45 is attached to the COLLECT button 31 and outputs a switch signal to a CPU 50 (refer to FIG. 5).

The GAME RULES button 32 is a button to be depressed when the player is not sure about the game operation method and the like such that each kind of help information is displayed on the upper liquid crystal display 3 and the lower liquid crystal display 4. To such GAME RULES button 32, a GAME RULES switch 46 is attached such that the GAME RULES switch 46 outputs a switch signal to the CPU 50 upon the depression of the GAME RULES button 32 (refer to FIG. 5).

The BET 1 PER LINE button 33 is a button to be depressed once such that one bet from the credit amount the player currently owns is bet for each activated pay line. To the BET 1 PER LINE button 33, a 1-BET switch 57 is attached and outputs a switch signal to the CPU 50 based on depression of the BET 1 PER LINE button 33 as it is depressed (refer to FIG. 5).

The BET 3 PER LINE button 34 is a button to be depressed so as to start the game with 3 bets for each activated pay line. To the BET 3 PER LINE button 34, a 3-BET switch 58 is attached and outputs a switch signal to the CPU 50 upon depression of thereof (refer to FIG. 5).

Also, the BET 5 PER LINE button 35 is a button to be depressed so as to start the game with 5 bets for each activated pay line. To the BET 5 PER LINE button 35, a 5-BET switch 59 is attached and outputs a switch signal to the CPU 50 upon depression of thereof (refer to FIG. 5).

Therefore, the bet number for each line of the activated pay lines is determined by depression of the BET 1 PER LINE button 33, the BET 3 PER LINE button 34, the BET 5 PER LINE button 35.

Also, the WIN START FEATURE button 36 is a button to be depressed to start the bonus game to be described later and to add the payout amount obtained in the bonus game. To the WIN START FEATURE button 36, a WIN-START switch 47 is attached and outputs a switch signal to the CPU 50 upon depression thereof (refer to FIG. 5).

The PLAY 1 LINE button 37 is a button to start the game upon depression thereof as the number of the activated pay lines is set to one such that “the center line 7A” is activated. To the PLAY 1 LINE button 37, a 1-LINE switch 60 is attached and outputs a switch signal to the CPU 50 (refer to FIG. 5).

The PLAY 3 LINES button 38 is a button to be depressed so as to start the game upon depression thereof as the number of the activated pay lines is set to three such that “the center line 7A, the top line 7B and the bottom line 7C” are activated. To the PLAY 3 LINES button 38, a 3-LINE switch 61 is attached and outputs a switch signal to the CPU 50 upon depression thereof (refer to FIG. 5).

The PLAY 5 LINES button 38 is a button to be depressed so as to start the game upon depression thereof as the number of the activated pay lines is set to five such that “the center line 7A, the top line 7B, the bottom line 7C, the cross-down line 7D and the cross-up line 7E” are activated. To the PLAY 5 LINES button 39, a 5-LINE switch 62 is attached and outputs a switch signal to the CPU 50 upon depression thereof (refer to FIG. 5).

Also, the PLAY 1 LINE button 37, the PLAY 3 LINES button 38 and the PLAY 5 LINES button 39 also work as a start button to start displaying respective symbols variably in the left reel 21, the center reel 22 and the right reel 23 on the lower liquid crystal display 4 with the current bet number and the current number of activated pay lines based on depression of these buttons.

The GAMBLE RESERVE button 40 is a button to be depressed when the player leaves the slot machine or when the game process is shifted into the double down game after the bonus game ends. Here, the double down game is a game utilizing the credit obtained in the bonus game, but the details are omitted.

To the GAMBLE RESERVE button 40, a GAMBLE-RESERVE switch 48 is attached and outputs a switch signal to the CPU 50 upon depression thereof (refer to FIG. 5).

On the coin insertion part 9, a coin sensor 49 is disposed and a coin detection signal is outputted to the CPU 50 via the coin sensor 49 when a coin is inserted into the coin insertion part 9 (refer to FIG. 5) such that a credit corresponding to the number of inserted coins is added. Also, a bill sensor 67 is disposed on the bill insertion part 10 so that a bill detection signal is outputted to the CPU 50 via the bill sensor 67 when a bill is inserted into the bill insertion part 10 (refer to FIG. 5) such that a credit corresponding to the number of inserted bills is added.

Also, around a lower part of the cabinet, the coin payout opening 15 is formed as well as the coin receiving part 16 for receiving coins from the coin payout opening 15. In the coin payout opening 15, a hopper 71 that can discharge coins one by one and a coin detection part 73 comprising a sensor and the like to be described later are disposed (refer to FIG. 5), such that the coin detection part 73 detects the number of coins discharged from the coin payout opening 15. Also, it is OK to configure the slot machine so as to discharge a receipt-like piece of paper on which the number of coins to be paid out instead of paying out the coins directly. In such an occasion, the player brings the discharged receipt to the counter of the gaming arcade so as to replace the receipt with the actual prizes.

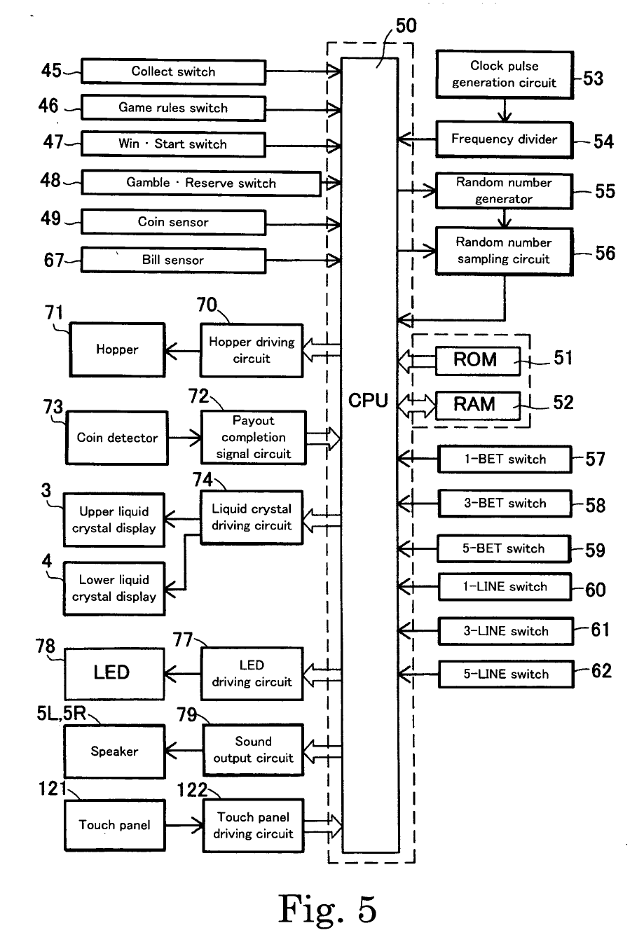

Subsequently, examples of symbols to be displayed variably as being scrolled in the left reel 21, the center reel 22 and the right reel 23 on the lower liquid crystal display 4 in both base game and bonus game in reference to FIG. 4. In FIG. 4, a first group of symbols 92 are a column of symbols to be displayed variably from the top to the bottom in the left reel 21. A second group of symbols 93 are a column of symbols to be displayed variably from the top to the bottom in the center reel 22. A third group of symbols 94 are a column of symbols to be displayed variably from the top to the bottom in the right reel 23. Then, thirty three (33) symbols in total are arranged in the first group of symbols 92 through the third group of symbols 94.

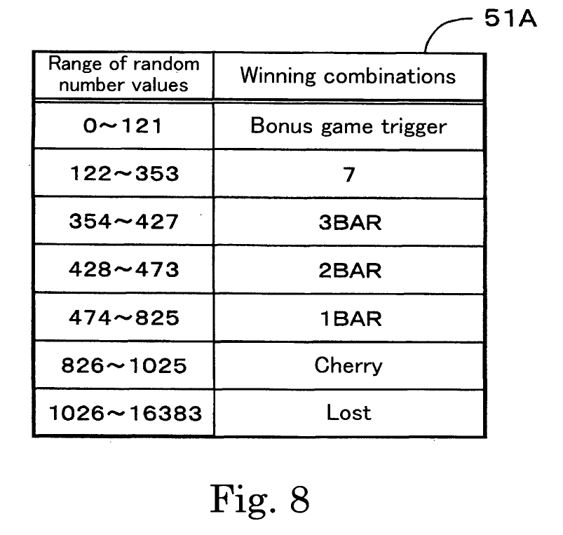

Here, each group from the first group of symbols 92 through the third group of symbols 94 corresponds to a first kind of group and dot data to form images of the columns of symbols shown in the first group of symbols 92 through the third group of symbols 94 are stored in a ROM 82 (refer to FIG. 6).

Here, the first group of symbols 92 through the third group of symbols are composed of triple-BAR 95, Cherry 96, double-BAR 97, SEVEN (7) 98, single-BAR 99 and blank (an area where no symbols exist) 100 such that each group of symbols is composed of eleven (11) symbols as these kinds of symbols are combined appropriately.

Also, in the second group of symbols 93 is especially composed of one trigger symbol 101. The trigger symbol 101 is a symbol to shift the game process to the free game such that the game process is shifted from the base game to the free game when the trigger symbol 101 is stopped and displayed on any one of the activated pay lines 7A through 7E.

Here, the free game is a game to be played subsequently after a normal game is conducted and is often designed to be more advantageous to the player. When the game process shifted into the free game, ten (10) games, twenty (20) games or thirty (30) games may be played consecutively without betting depending on the rank of the free game. Here, the bonus game may comprise various kinds of games more advantageous to the player to be played after the base game such as the above-mentioned free game, a second game, and so on.

Here, when each group of symbols 92 through 94 are scrolled in each of the left reel 21, the center reel 22 and the right reel 23, three symbols are stopped and displayed in a stationary mode in each of stop display areas 211 through 213, 221 through 223 and 231 through 233 (refer to FIG. 2). In the event, the symbols displayed in a stationary mode are determined based on an internal lottery to be described later.

Also, various kind of winning combinations are set up beforehand based on a plurality of kinds of combinations of symbols and when a combination of symbols corresponding to one of the winning combinations are stopped on any of the pay lines 7A through 7E (refer to FIG. 1), the credit is added depending on the kind of winning combination. In particular, when the trigger symbol 101 is stopped and displayed on the activated pay line, the game process is shifted to the free game.

Next, examples of symbols to be displayed variably as being scrolled in the top reel 24, the middle reel 25 and the bottom reel 26 after being displayed variably in the left reel 21, the center reel 22 and the right reel 23 are explained. Here, in the following explanation, displaying symbols variably in the left reel 21, the center reel 22 and the right reel 23 is referred to as a first stage of variable display; and displaying symbols variably in the top reel 24, the middle reel 25 and the bottom reel 26 is referred to as a second stage of variable display.

Here, examples of symbols to be displayed variably in the top reel 24, the middle reel 25 and the bottom reel 26 in the second stage of variable display are determined on each occasion when a combination of symbols are stopped and displayed in the stationary display areas 211 through 213, 221 through 223 and 231 through 233 (refer to FIG. 2) as a result of the first stage of variable display. More specifically, among the nine (9) symbols being displayed in a stationary mode, the fourth group of symbols is composed of three symbols being displayed in a stationary mode in the first stationary display area 211, the fourth stationary display area 221 and the seventh stationary display area 231; the fifth group of symbols is composed of three symbols being displayed in a stationary mode in the second stationary display area 212, the fifth stationary display area 222 and the eighth stationary display area 232; and the sixth group of symbols is composed of three symbols being displayed in a stationary mode in the third stationary display area 213, the sixth stationary display area 223 and the ninth stationary display area 233. And a row of symbols in the fourth group of symbols are displayed variably from right to left or from left to right in the top reel 24; a row of symbols in the fifth group of symbols are displayed variably from right to left or from left to right in the middle reel 25; and a row of symbols in the sixth group of symbols are displayed variably from right to left or from left to right in the bottom reel 26.

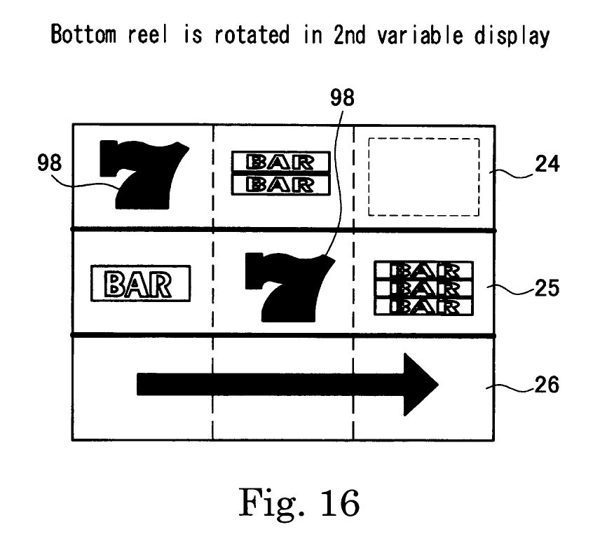

For example, as shown in FIG. 15, SEVEN (7) 98 in the first stationary display area 211, single-BAR 99 in the second stationary display area 212, blank 100 in the third stationary display area 213, double-BAR 97 in the fourth stationary display area 221, SEVEN (7) 98 in the fifth stationary display area 222, SEVEN (7) 98 in the sixth stationary display area 223, blank 100 in the seventh stationary display area 231, triple-BAR 95 in the eighth stationary display area 232 and cherry 96 in the ninth stationary display area are displayed in a stationary mode. Three symbols of SEVEN (7) 98 displayed in a stationary mode in the first stationary display area 211, double-BAR 97 displayed in a stationary mode in the fourth stationary area 221 and blank 100 displayed in a stationary mode in the seventh stationary display area 231 constitute the fourth group of symbols and are subsequently displayed variably in the top reel 24 in the second stage of variable display. Also, single BAR 99 displayed in a stationary mode in the second stationary display area 212, SEVEN (7) displayed in the fifth stationary display area 222, and triple-BAR 95 displayed in the eighth stationary display area 232 constitute the fifth group of symbols and are subsequently displayed variably in the middle reel 25 in the second stage of variable display. Also, blank 100 displayed in a stationary mode in the third display area 213, SEVEN (7) 98 displayed in a stationary mode in the sixth stationary display area 223 and cherry 96 displayed in a stationary mode in the ninth stationary display area 233 constitute the sixth group of symbols and are subsequently displayed variably in the bottom reel 26 in the second stage of variable display.

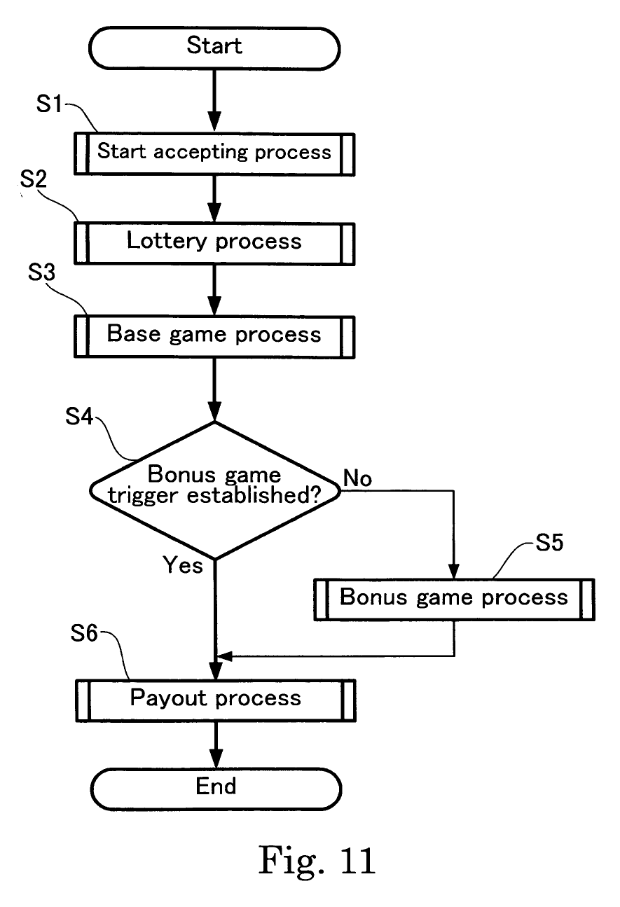

Further, the second stage of variable display in the top reel 24, the middle reel 25 or the bottom reel 26 is not always conducted after the first stage of variable display, and even if the second stage of variable display is conducted, symbols in all three reels are not necessarily displayed variably. Also, the moving direction of the symbols in such variable display may be changed for each game. More specifically, it is determined whether to conduct the second stage of variable display or not, which reel(s) is(are) displayed variably, and in which direction symbols are moved (from right to left, or from left to right) based on a result of the internal lottery being conducted as well as a lottery for selecting the winning combination (refer to FIG. 10).

Next, the configuration of the control system of the slot machine 1 is explained in reference to FIG. 5. FIG. 5 is a block diagram showing schematically the control system of the slot machine.

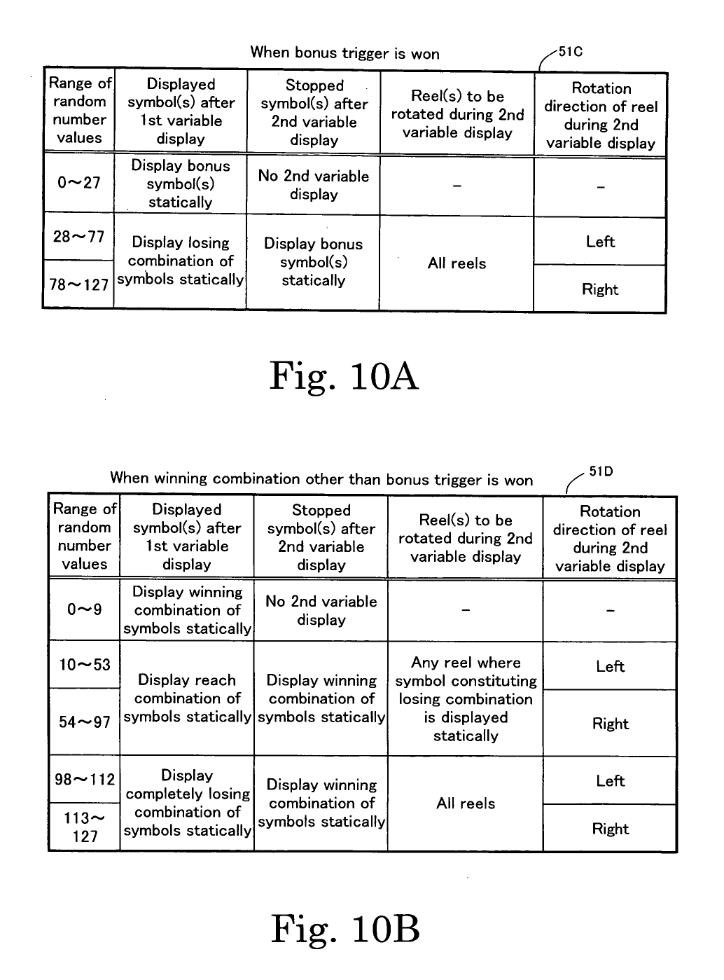

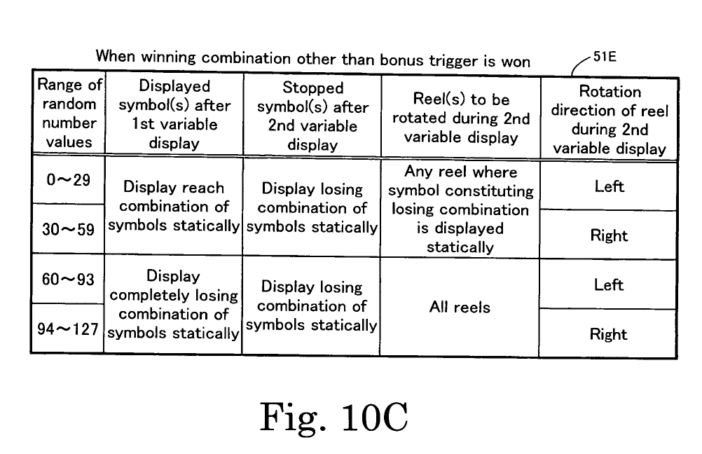

In FIG. 5, the control system of the slot machine 1 is basically configured with the CPU 50 as the core and the CPU 50 is connected with the ROM 51 and the RAM 52. The ROM 51 stores a main process program, a base game process program, a bonus game process program, a winning combination lottery table for selecting the winning combination (refer to FIG. 8), a payout table for setting the credit to be paid out based on the winning combination (refer to FIG. 9), a symbol effect lottery table for selecting a variable mode of the symbols in the first stage and the second stage of variable displays based on the winning combination (refer to FIG. 10), various kinds of programs and data tables necessary for controlling the slot machine 1.

Also, the CPU 50 is connected with a clock pulse generation circuit 53 and a frequency divider 54; and further with a random number generator 55 to generate the random number and a random number sampling circuit 56. The random number sampled by the random number sampling circuit 56 is utilized for various kinds of lotteries to select the winning combination and the like. Further, the CPU 50 is connected with the COLLECT switch attached to the COLLECT button 31, the GAME-RULES switch 46 attached to the GAME RULES button 32, the 1-BET switch 57 attached to the BET 1 PER LINE button 33, the 3-BET switch 58 attached to the BET 3 PER LINE button 34, the 5-BET switch 59 attached to the BET 5 PER LINE button 35, the WIN-START switch 47 attached to the WIN START FEATURE button 36, the 1-LINE switch 60 attached to the PLAY 1 LINE button 37, the 3-LINES switch 61 attached to the PLAY 3 LINES button 38, the 5-LINES switch 62 attached to the PLAY 5 LINES button 39, and the GAMBLE RESERVE switch 48 attached to the GAMBLE RESERVE button 40, respectively. The CPU 50 controls various kinds of operations corresponding to respective buttons based on respective switch signals outputted respective switches upon depression of respective buttons.

Further, the CPU 50 is connected with the coin sensor 49 disposed on the coin insertion part 9 and the bill sensor 67 disposed on the bill insertion part 10. The coin sensor 49 detects inserted coins from the coin insertion part 9 and the CPU 50 calculates the number of inserted coins based on the coin detection signals outputted by the coin sensor 49. The bill sensor 67 detects the kind and amount of bill being inserted from the bill insertion part 10 and the CPU 50 calculates the credit number equivalent to the amount of the inserted bill based on the bill detection signals outputted by the bill sensor 67.

The CPU 50 is connected with the hopper 71 via a hopper driving circuit 70. When a driving signal is outputted from the CPU 50 to the hopper driving circuit 70, the hopper 71 pays out a predetermined number of coins from the coin payout opening 15.

Further, the CPU 50 is connected with the coin detection part 73 via a payout completion signal circuit 72. The coin detection part 73 is disposed in the coin payout opening 15 and when it detects a predetermined number of coins are paid out from the coin payout opening 15, a coin payout detection signal is outputted to the payout completion signal circuit 72 and the payout completion signal circuit 72 outputs the payout completion signal to the CPU 50 based on the outputted coin payout detection signal. Further, the CPU 50 is connected with the upper liquid crystal display 3 and the lower liquid crystal display 4 via the liquid crystal driving circuit 74 such that the CPU 50 controls the upper liquid crystal display 3 and the lower liquid crystal display 4.

In this point, the liquid crystal driving circuit 74 is, as shown in FIG. 6, composed of a program ROM 81, an image ROM 82, an image control CPU 83, a work RAM 84, a VDP (video display processor) 85 and a video RAM 86. And the program ROM 81 stores various kinds of selection tables and an image control program relating to the display contents on the upper liquid crystal display 3 and the lower liquid crystal display 4. Also, the image ROM 82 stores dot data to form images such as symbols in FIG. 4 to be displayed variably, for example, in each reel 21 through 26 on the lower liquid crystal display 4.

The image control CPU 83 determines images to be displayed on the upper liquid crystal display 3 and the lower liquid crystal display 4 by selecting dot data having been stored in the image ROM 82 according to the image control program having been stored in the program ROM 81 based on the parameter set up by the CPU 50. Also the work RAM 84 is configured as a temporary storage means when the image control program is executed by the image control CPU 83. Also, the VDP 85 outputs to the upper liquid crystal display 3 and the lower liquid crystal display 4 image data, which form images corresponding to the display content determined by the image control CPU 83. Thus, columns of symbols shown in respective reels 21 through 26, for example, are displayed as being scrolled on the lower liquid crystal display 4.

Also, the CPU 50 is connected with an LED 78 via an LED driving circuit 77. The LED 78, which is exemplified as many LED illuminators or lamps disposed on the front face of the slot machine 1, is controlled to be lit by the LED driving circuit 77 based on a driving signal from the CPU 50 when various kinds of effects are performed. In particular, in the slot machine 1 of the first embodiment, the LED 78 is lit to enhance the effects during the bonus game to be described later.

Also, a sound output circuit 79 and speakers 5L, 5R are connected with the CPU 50 such that the speakers 5L, 5R output voice and effect sounds when various kinds of effects are performed based on the output signal from the sound output circuit 79.

Also, the CPU 50 is connected with a touch panel 121 via a touch panel driving circuit 122. The touch panel 121 is disposed on the lower display 4 and can detect which part is touched and further in which direction the touched part is moved based on position information in the coordinate system of the place the player touches via the touch panel driving circuit 122.

Also, the ROM 51 stores a winning combination lottery table 51A for conducting a lottery of a winning combination of the free game to be carried out in a base game mode and a bonus game mode according to a random number (refer to FIG. 8), a payout table 51B storing various kinds of winning combinations (refer to FIG. 9) and symbol effect lottery tables 51C through 51E for selecting the variable mode of the symbols to be displayed variably during the first and the second stages of variable displays based on the winning combination.

Next, when the base game and the free game are performed with respective reels 21 through 26 of the slot machine 1, lottery tables to be used for conducting a lottery of the winning combination (prize-winning combination) and payout tables listing set payouts based on the winning combination, which are stored in the ROM 51, are explained by referring to FIG. 8. FIG. 8 shows a lottery table of the winning combination to be utilized when the base game and the free game are played. FIG. 9 shows a payout table indicating payout amount of the credit based on the winning combination.

As shown in FIGS. 8 and 9, the range of random number values is from 0 to 16383, and if the random number value is in the range from 0 to 121, the bonus game trigger is won. In this case, the game process shifts to the free game as the bonus game when the trigger symbol 101 is displayed in a stationary mode along any of the activated pay lines 7A through 7E in any of the reels 21 through 26 and when the game process is in the base game mode.

And, when the random number value having been sampled via the random number sampling circuit 56 is in the range from 122 to 855, the winning combination of the SEVEN (7) is won. In this case, three SEVEN (7) symbols are displayed in a stationary mode consecutively along any of the activated pay lines 7A through 7E after the first or the second variable display. In such a case, three SEVENs 98 are consecutively aligned to any of the activated pay lines 7A through 7E after the first stage of variable display or the second stage of variable display such that the credit number based on the bet number and the current game rate is added as the payout. That is to say, the value given by multiplying the bet number and the payout rate (multiplying factor: X 100) is added as the payout (e.g., 500 credits in the case of 5 bets).

In a similar manner, when the sampled random number value is in the range from 354 to 427, the winning combination of triple-BAR is won. When the sampled random number value is in the range from 428 to 473, the winning combination of double-BAR is won. When the sampled random number value is in the range from 474 to 825, the winning combination of single-BAR is won. When the sampled random number value is in the range from 826 to 1025, the winning combination of cherry is won. When each winning combination is won, three consecutive winning symbols are displayed in a stationary mode after the first and the second stage of variable displays, and a credit number made by multiplying the bet number and the payout rate is added as the payout return.

Here, when the sampled random number value is in the range from 1026 to 16383, a “losing” combination is won (or the player is lost in the game). In such a case, the losing combination of symbols other than any winning combinations are displayed in a stationary mode along any of the pay lines 7A through 7E after the first and the second variable displays and no credit number is added (i.e., the payout amount is zero).

Next, the symbol effect lottery table to be stored in the ROM 51 and to be utilized in conducting a lottery for selecting a variable mode of the symbols (effect patterns) during the first and the second variable displays, when the base game is performed by utilizing respective reels 21 through 26 in the slot machine 1, is explained by referring to FIGS. 10A through 10C. FIGS. 10A through 10C show symbol effect lottery tables for selecting the variable mode of the symbols in the base game with the slot machine according to the first embodiment.

As shown in FIGS. 10A through 10C, the symbol effect lottery table comprises three kinds of tables: a symbol effect lottery table 51C to be utilized when the bonus trigger is won by the lottery for the winning combination as the winning combination lottery table 51A is utilized, a symbol effect lottery table 51D to be utilized when a winning combination other than the bonus trigger is won, and a symbol effect lottery table 51E to be utilized when no winning combination is won (i.e., the player is lost in the game). Also, the range of random number values to be utilized in each symbol effect lottery table 51C through 51E is identical such that it is from 0 to 127.

First, the symbol effect lottery table 51C to be utilized, when the bonus trigger is won, is explained. When the random number value sampled via the random number sampling circuit 56 is in the range from 0 to 27, an effect pattern to be displayed variably is selected such that the trigger symbol 101 is displayed in a stationary mode along any of the activated pay lines 7A through 7E in any one of the left reel 21, the center reel 22 and the right reel 23 after the first stage of variable display.

Also, when the random number value is in the range from 28 to 77, another effect pattern is selected such that nine symbols are once displayed in a stationary mode after the first stage of variable display wherein the combination of the nine symbols is the losing combination so as not to include any of the winning combination (three symbols of a kind other than the blank 100 consecutively displayed in a stationary mode along any of the activated pay lines 7A through 7E) in the left reel 21, the center reel 22 and the right reel 23. Then, the second stage of variable display is conducted such that all symbols in the top reel 24, the middle reel 25 and the bottom reel 26 are rotated from right to left and the trigger symbol 101 is displayed in a stationary mode along any of the activated pay lines 7A through 7E in any of the reels. The above-described is the selected effect pattern.

Also, when the random number value is in the range from 78 to 127, yet another effect pattern is selected such that symbols in the losing combination are once displayed in a stationary mode in the left reel 21, the center reel 22 and the right reel 23 after the first stage of variable display. Then, the second stage of variable display is conducted such that all symbols in the top reel 24, the middle reel 25 and the bottom reel 26 are rotated from left to right and the trigger symbol 101 is displayed in a stationary mode along any of the activated pay lines 7A through 7E in any of the reels. The above-described is the selected effect pattern.

Next, the symbol effect lottery table 51D to be utilized, when a winning combination other than the bonus trigger is won, is explained. When the random number value sampled via the random number sampling circuit 56 is in the range from 0 to 9, an effect pattern to be displayed variably is selected such that the winning combination of symbols are displayed in a stationary mode along any of the activated pay lines 7A through 7E in the left reel 21, the center reel 22 and the right reel 23 after the first stage of variable display.

Also, when the random number value is in the range from 10 to 53, another effect pattern is selected such that a combination of symbols having one symbol that does not constitute a certain winning combination with the other symbols are once displayed along any of the activated pay lines 7A through 7E in the left reel 21, the center reel 22 and the right reel 23 after the first stage of variable display. For example, in the case of a so-called 3×3 (three by three) matrix display areas, two symbols constituting the certain winning combination are positioned consecutively along the activated pay line, but one particular kind of symbol to complete the certain winning combination with the two symbols is not disposed at a position next to the two symbols. Or two symbols of the same kind are positioned on both sides of one symbol between the two symbols, and the one symbol does not constitute the certain winning combination with the two symbols. Such combination of symbols may be referred to as “reach combination,” hereafter. Therefore, the reach combination may include a combination of symbols having only one symbol (or one kind of symbol) is missing from a complete winning combination. Then, a combination of symbols including the above-mentioned one symbol (referred to as “losing symbol,” hereafter) that does not constitute the certain winning combination in the top reel 24, the middle reel 25 or the bottom reel 26 are rotated from right to left such that a constituent symbol (referred to as winning symbol, hereafter) may be displayed in a stationary mode after the second stage of variable display, the constituent symbol constituting the certain winning combination if disposed at the position where the losing symbol used to be (or exist).

Also, when the random number value is in the range from 54 to 97, another effect pattern is selected such that the reach combination of symbols are once displayed along any of the activated pay lines 7A through 7E in the left reel 21, the center reel 22 and the right reel 23 after the first stage of variable display. Then, the combination of symbols including the losing symbol in the top reel 24, the middle reel 25 or the bottom reel 26 are rotated from left to right such that the winning symbol may be displayed in a stationary mode after the second stage of variable display.

Also, when the random number value is in the range from 98 to 112, another effect pattern is selected such that a combination not including the winning combination or the reach combination (referred to as “completely losing combination,” hereafter) are once displayed in the left reel 21, the center reel 22 and the right reel 23 after the first stage of variable display. Then, the combinations of symbols in the top reel 24, the middle reel 25 and the bottom reel 26 are rotated from right to left such that the winning symbol that constitutes the winning combination may be displayed in a stationary mode along any of the activated pay lines 7A through 7E after the second stage of variable display.

Also, when the random number value is in the range from 113 to 127, another effect pattern is selected such that the completely losing combination are once displayed in the left reel 21, the center reel 22 and the right reel 23 after the first stage of variable display. Then, the winning symbol that constitutes the winning combination may be displayed in a stationary mode along any of the activated pay lines 7A through 7E after the second stage of variable display.

Further, the symbol effect lottery table 51E to be utilized, when no winning combinations are won, is explained. When the random number value is in the range from 0 to 29, another effect pattern is selected such that a reach combination corresponding to any one of the winning combinations are once displayed along any of the activated pay lines 7A through 7E in the left reel 21, the center reel 22 and the right reel 23 after the first stage of variable display. Then, a combination of symbols having the losing symbol in the top reel 24, the middle reel 25 or the bottom reel 26 are rotated from right to left such that any symbol other than the winning symbol may be displayed in a stationary mode at the position where the losing symbol used to be (or exist) after the second stage of variable display.

Also, when the random number value is in the range from 30 to 59, another effect pattern is selected such that a reach combination of symbols are once displayed along any of the activated pay lines 7A through 7E in the left reel 21, the center reel 22 and the right reel 23 after the first stage of variable display. Then, a combination of symbols having the losing symbol in the top reel 24, the middle reel 25 or the bottom reel 26 are rotated from left to right such that any symbol other than the winning symbol may be displayed in a stationary mode at the position where the losing symbol used to be (or exist) after the second stage of variable display.

Also, when the random number value is in the range from 60 to 93, another effect pattern is selected such that a completely losing combination of symbols are once displayed in the left reel 21, the center reel 22 and the right reel 23 after the first stage of variable display. Then, the combinations of symbols in the top reel 24, the middle reel 25 and the bottom reel 26 are rotated from right to left such that symbols in the losing combination that does not include any winning combinations may be displayed in a stationary mode along any of the activated pay lines 7A through 7E after the second stage of variable display.

Also, when the random number value is in the range from 94 to 127, another effect pattern is selected such that a completely losing combination of symbols are once displayed in the left reel 21, the center reel 22 and the right reel 23 after the first stage of variable display. Then, the combinations of symbols in the top reel 24, the middle reel 25 and the bottom reel 26 are rotated from left to right such that symbols in the losing combination that does not include any winning combinations may be displayed in a stationary mode along any of the activated pay lines 7A through 7E after the second stage of variable display.

Here, in the aforementioned first embodiment, the lottery for the winning combination by utilizing the winning combination lottery table 51A and the effect pattern lottery of the variable display by utilizing the symbol effect lottery tables 51C through 51E are conducted at a separate timing by utilizing different tables. However, the lotteries for the winning combination and the effect pattern may be conducted at the same time by utilizing one table defining both winning combinations and effect patterns.

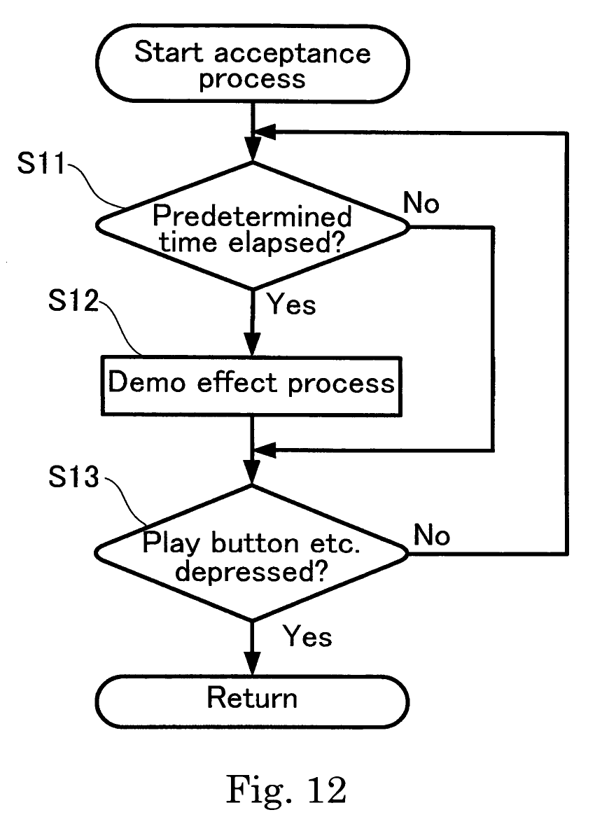

Subsequently, according to the first embodiment, the main process program of the slot machine 1 being configured as mentioned above is explained in reference to FIG. 11. FIG. 11 is a flow chart of the main process program of the slot machine according to the first embodiment. Here, each program shown by the flow chart of the following FIGS. 11 through 14 is stored in the ROM 51 and the RAM 52 with which the slot machine 1 is provided such that each program is executed by the CPU 50.

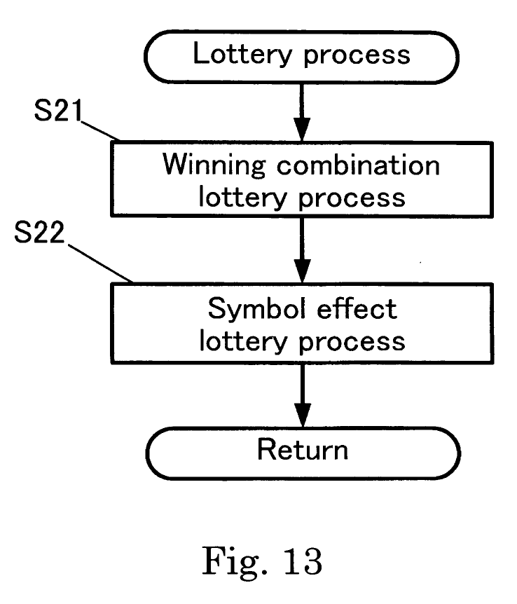

In FIG. 11, first of all, in the step 1 (step is abbreviated as “S”, hereafter), a start acceptance process to be described later in reference to FIG. 12 is conducted. In the process, based on an operation of the BET 1 PER LINE button 33, an operation of the BET 3 PER LINE button 34, an operation of the BET 5 PER LINE button 35, an operation of the PLAY 1 LINE button 37, an operation of the PLAY 3 LINES button 38 and an operation of the PLAY 5 LINES button 39, switch signals from the 1-BET switch 57, the 3-BET switch 58, the 5-BET switch 58, the 1-LINE switch 60 and the 3-LINES switch 61, the 5-LINES switch 62 are received (or accepted). When the switch signal outputted by each switch is received, the game is started.

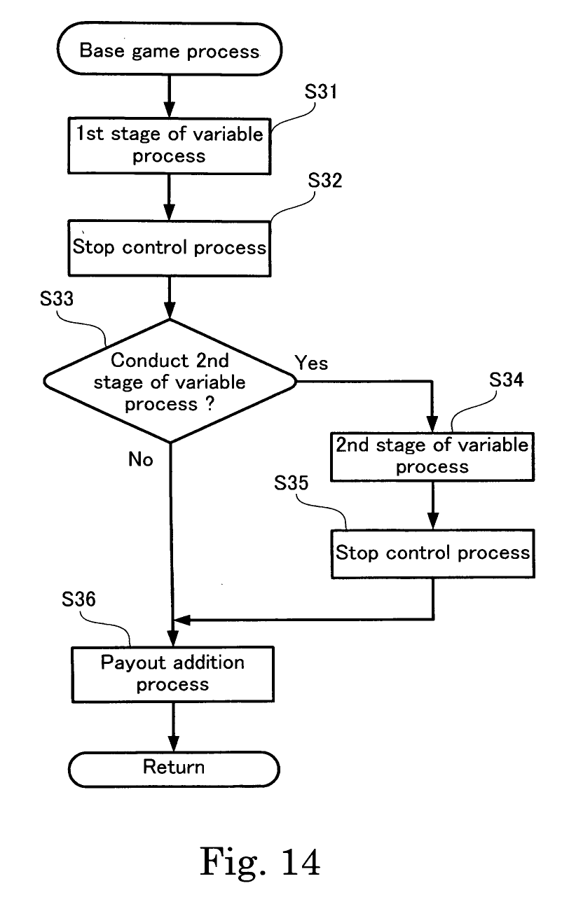

Then, in S2, a lottery process to be described later in reference to FIG. 13 is conducted based on the switch signals outputted by the 1-LINE switch 60, the 3-LINES switch 61, the 5-LINES switch 62.

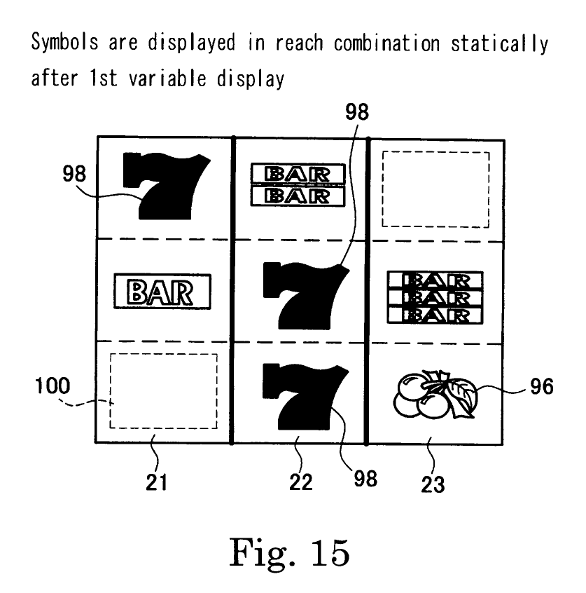

In S3, a base game process is conducted as described later in reference to FIG. 14. Then, the program proceeds to S4 and it is determined whether the bonus game is won or not. More specifically, in the lottery process in S2, the bonus game is won when it is determined that the bonus game trigger is won.

Then, when it is determined that the bonus game is won (S4: YES), the program proceeds to S5 such that the free game as the bonus game is played subsequently to the base game. Here, the free game is substantially the same free game as is generally used and played such that symbols are displayed variably and statically with the left reel 21, the center reel 22 and the right reel 23 a predetermined number of times and a payout amount preset is added for each time based on each combination of symbols displayed statically.

Then, a payout process is conducted in S6 to pay out the credit equivalent to the payout amount having been added and stored in the base game process in S3 and in the bonus game process in S5. The payout process, the credit equivalent to the payout amount of the base game is paid out if the bonus game is not conducted, and the credit equivalent to the payout amount of both base game and bonus game is paid out if the bonus game is conducted. Then, the main process ends after the aforementioned payout process.

Subsequently, in the slot machine 1 according to the first embodiment, the start acceptance process being conducted in the S1 is explained in reference to FIG. 12. FIG. 12 shows a flow chart of the start acceptance process program to be conducted in S1.

In the start acceptance process, the CPU 50 first determines whether a predetermined period of time (e.g., 15 second) has elapsed or not. Here, the program proceeds to S13 without doing anything if it is determined that the predetermined period of time has not elapsed (S11: NO), but the program proceeds to S12 in which a demonstration effect is performed on the upper liquid crystal display 3 and/or the lower liquid crystal display 4 if it is determined that the predetermined period of time has elapsed (S11: YES), and the program proceeds to S13.

Then, in S13, it is determined whether the operation of the PLAY 1 LINE button 37, the operation of the PLAY 3 LINES button 38, or the operation of the PLAY 5 LINES button 39 is conducted or not. Here, if it is determined that the operation of the PLAY 1 LINE button 37 or any of the other operations are not conducted (S13: NO), the program returns to S11 and repeats the aforementioned processes. If it is determined that the operation of the PLAY 1 LINE button 37 or any of the other operations are conducted (S13: YES), the start acceptance process is terminated even in the middle of the demonstration effect and the program proceeds to a lottery process (S2).

Here, in the determination process of the S13, the determination may be rendered not only based on these operation signals, but also based on other input signals.

Next, the lottery process to be conducted in the S2 with the slot machine 1 according to the first embodiment is explained in reference to FIG. 13. FIG. 13 shows a flow chart of the lottery process program with the slot machine according to the first embodiment.

In the lottery process, the lottery process for selecting the winning combination is first conducted in S21. Here, the lottery for the winning combination in the base game. More specifically, the winning combination (any one of “Bonus game trigger,” “SEVEN (7),” “triple BAR,” “double BAR,” “single BAR,” “Cherry,” and “Losing”) in the current game is determined with the winning combination lottery table 51A (refer to FIG. 8) as a random number value is sampled from the range of 0 through 16383 by the sampling circuit 56 as mentioned before.

Subsequently, a symbol effect lottery process is conducted in S22 based on the lottery result of the S21. More specifically, a random number value in the range from 0 to 127 is sampled by the random number sampling circuit 56 and any one of the symbol effect lottery tables 51C through 51E is selected based on the winning combination such that it is determined whether to conduct the second stage of variable display in the top reel 24, the middle reel 25 or the bottom reel 26 and that it is determined which reel is to be subject to the second stage of variable display and in which direction the reel is to be rotated if it is determined the second stage of variable display is to be conducted.

Next, the base game process to be conducted in the S3 with the slot machine 1 according to the first embodiment is explained in reference to FIG. 14. FIG. 14 shows a flow chart of the base game process program in the slot machine according to the first embodiment.

In the base game process, various kinds of symbols are scrolled in the left reel 21, the center reel 22 and the right reel 23 (first stage of variable display) based on the switch signal accepted in the start acceptance process (S1), the switch signal having been outputted from any of the 1-LINE switch 60, the 3-LINES switch 61 and the 5-LINES switch 62. In the above-mentioned process, the symbols in the first group of symbols 92 (refer to FIG. 4) are displayed variably from the top to the bottom in the left reel 21, the symbols in the second group of symbols 93 (refer to FIG. 4) are displayed variably from the top to the bottom in the center reel 22, and the symbols in the third group of symbols 94 (refer to FIG. 4) are displayed variably from the top to the bottom in the right reel 23.

Subsequently, scrolling the symbols in any one of the left reel 21, the center reel 22 and the right reel 23 is stopped, and symbols are displayed in a stationary mode in respective stationary display areas 211 through 213, 221 through 223 and 231 through 233 (refer to FIG. 2A) based on the lottery result of the symbol effect lottery process in the aforementioned S22.

Then, it is determined whether to conduct the second stage of variable display in the top reel 24, the middle reel 25 and the bottom reel 26 subsequently to the first stage of variable display based on the lottery result of the symbol effect lottery process in the aforementioned S22. More specifically, it is determined not to conduct the second stage of variable display if the bonus trigger is won in the winning combination lottery process in the S21 and the random number value having been sampled in the symbol effect lottery process in the S22 is in the range from 0 through 27, or if any winning combination other than the bonus trigger is won in the winning combination lottery process in S21 and the random number value having been sampled in the symbol effect lottery process in the S22 is in the range from 0 through 9. It is determined to conduct the second stage of variable display in the other cases.

Then, if it is determined not to conduct the second stage of variable display (S33: NO), the payout amount determined by the payout table 51B in FIG. 9 is stored based on the winning combination of symbols being displayed in a stationary mode after the first stage of variable display (payout addition process: S36). The stored payout amount is paid out in the payout process in the S6 together with the payout amount of the bonus game if the bonus game is played.

Then, after such payout addition process, the program returns to the main process program and proceeds to the determination process in the S4.

On the other hand, if it is determined to conduct the second stage of variable display (S33: YES), the second stage of variable display by the top reel 24, the middle reel 25 and the bottom reel 26 after the first stage of variable display (S34) and each symbol comes to a halt and is displayed in a stationary mode (S35). Here, the variable mode of symbols during the second stage of variable display is determined based on a lottery result of the symbol effect lottery process in the S22 and a group of symbols belonging to a designated reel out of the fourth through sixth groups of symbols are displayed variably in a direction perpendicular (or orthogonal) to the direction of variable display during the first stage of variable display. By way of example, several patterns of variable modes of symbols in the second stage of variable display are shown and the variable mode is explained blew. FIGS. 15 through 22 show schematic diagrams of the variable modes of symbols during the second stage of variable display.

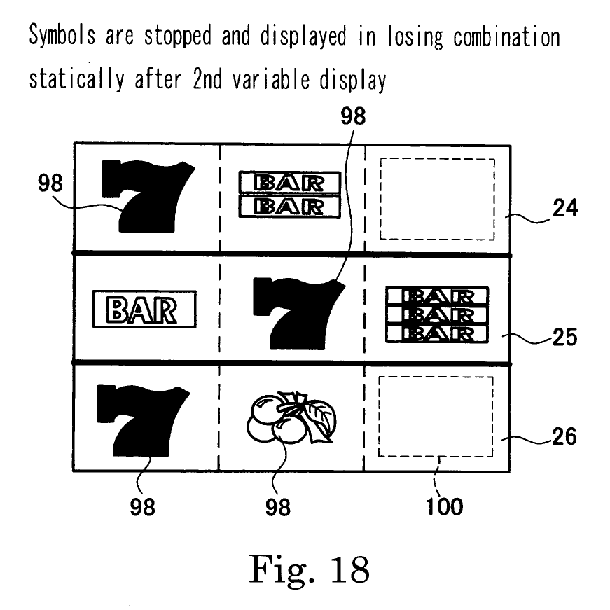

For example, in a case where the SEVEN (7) combination, which is other than the bonus trigger, is won during the winning combination lottery process in the S21 and the sampled random number value is in the range from 54 to 97 in the symbol effect lottery process in the S22, symbols including a reach combination of the SEVEN (7) winning combination are displayed in a stationary mode after the first stage of variable display as shown in FIG. 15, wherein the reach combination has only one SEVEN 98 off from an aligned position along the cross-down line 7D of the activated pay line. After that, the second stage of variable display is conducted such that only the bottom reel where a cherry 96, which does not make the winning combination, belongs is then rotated from left to right. And the SEVEN (7) symbol 98 is stopped at the ninth stationary display area 233 and displayed in a stationary mode as shown in FIG. 17 such that the SEVEN (7) winning combination is completed.

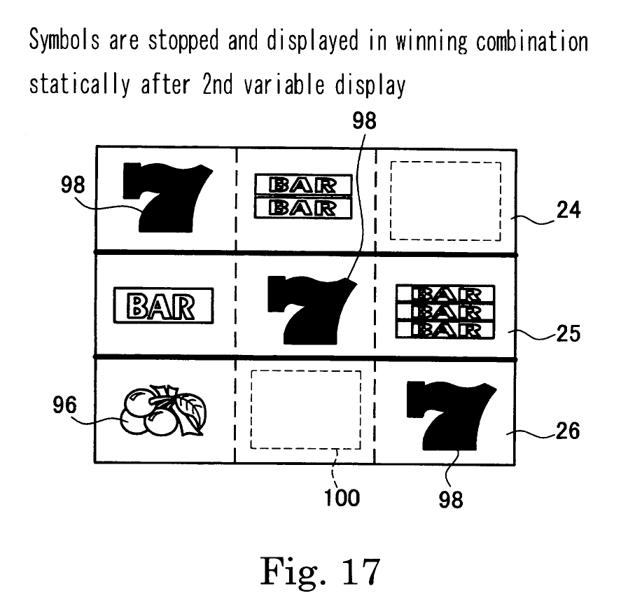

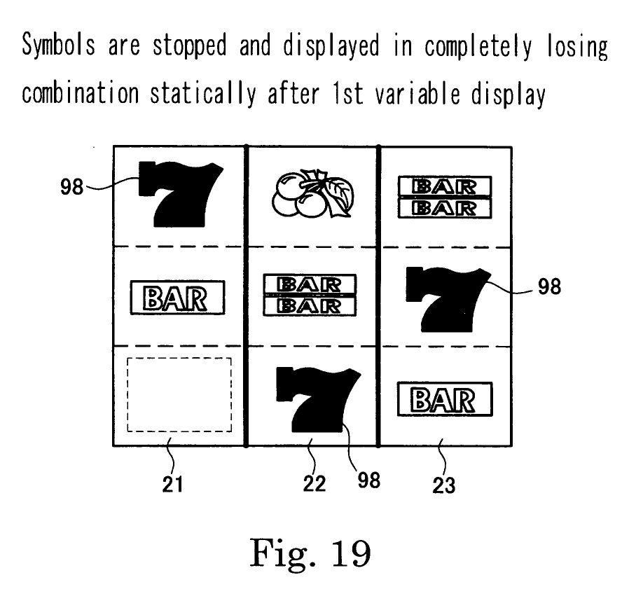

Further, in a case where no winning combination is won during the winning combination lottery process in the S21 and the sampled random number value is in the range from 30 to 59 in the symbol effect lottery process in the S22, after a similar variable display is conducted as shown in FIGS. 15 and 16, a blank symbol 100 is stopped at the ninth stationary display area 233 and displayed in a stationary mode as shown in FIG. 18 such that a losing combination that does not have any winning combination is made.

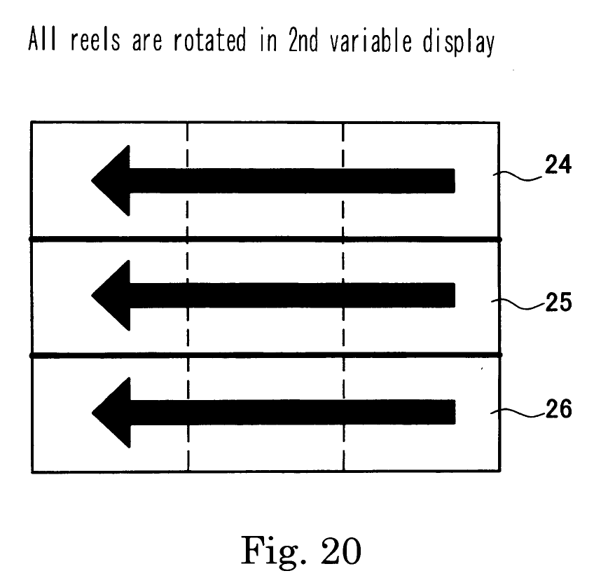

In a case where the SEVEN (7) combination, which is other than the bonus trigger, is won during the winning combination lottery process in the S21 and the sampled random number value is in the range from 98 to 112 in the symbol effect lottery process in the S22, symbols not including any winning combinations or even a reach combination of any winning combinations are displayed in a stationary mode after the first stage of variable display as shown in FIG. 19, wherein the displayed symbols are displayed in a completely losing combination. Here, although it appears that a reach combination of a double-BAR winning combination is shown along the cross-up line 7E, it is not the reach combination since the cross-up line 7E is not activated.

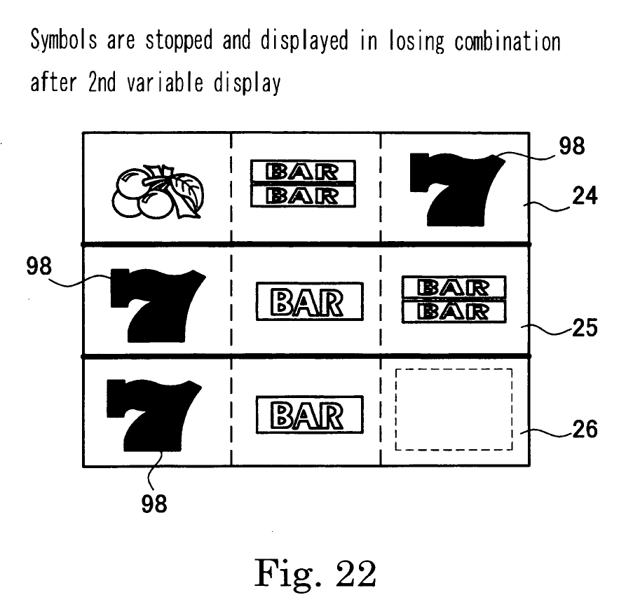

In addition, even if the cross-up line 7E is activated, it is also possible that the double-BAR winning combination is not to become the reach combination since there are no other double-BAR symbols displayed in a stationary mode in the display areas. Then, the second stage of variable display is conducted such that the top reel 24, the middle reel 25 and the bottom reel 26 are rotated from right to left. Then, SEVEN (7) symbols 98 are displayed in a stationary mode along the cross-up line 7E ash shown in FIG. 21 such that the SEVEN (7) winning combination is completed.

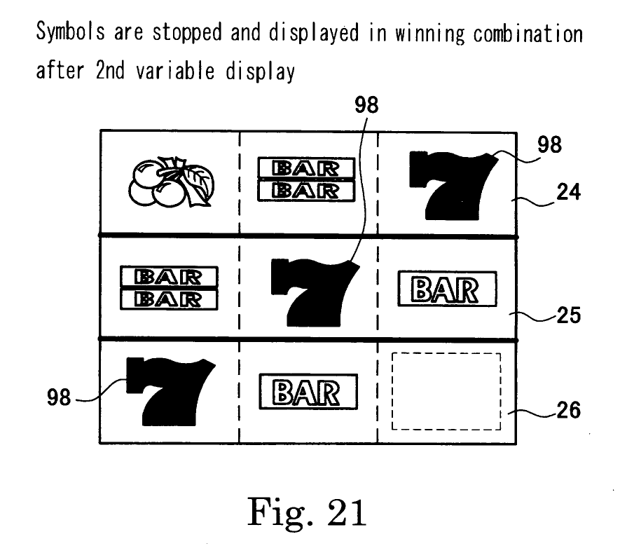

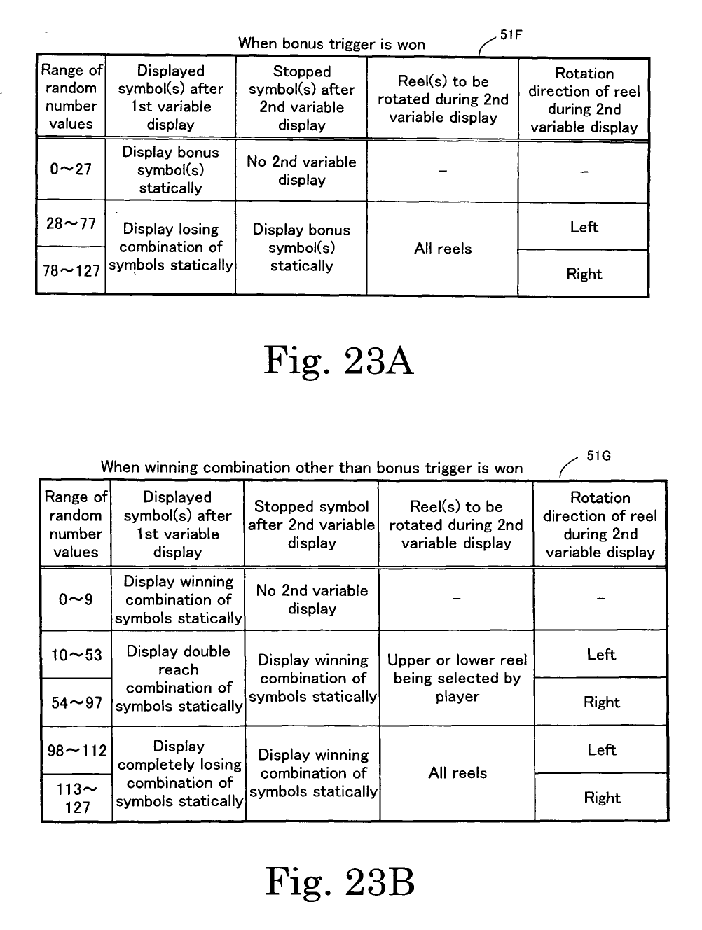

Also, in a case where no winning combination is won during the winning combination lottery process in the S21 and the sampled random number value is in the range from 60 to 93 in the symbol effect lottery process in the S22, after the first stage of variable display, as shown in FIG. 19, a completely losing combination of symbols that does not include even any reach combinations are displayed in a stationary mode. Then, the second stage of variable display is conducted such that the top reel 24, the middle reel 25 and the bottom reel 26 are rotated from right to left as shown in FIG. 20. Then, as shown in FIG. 22, symbols are displayed in a stationary mode in respective stationary display areas 211 through 213, 221 through 223 and 231 through 233 with a losing combination where no winning combination is made.

Subsequently, a payout amount determined based on the payout table 51B in FIG. 9 is stored in accordance with the winning combination displayed in a stationary mode in S36 after the second stage of variable display. The stored payout amount is paid out together with the payout amount of the bonus game in the payout process in the S6 if the bonus game is conducted.

Then, the program returns to the main process program after the payout addition process and proceeds to the determination process in S4.

As explained above, in the slot machine 1 of the first embodiment, after the first stage of variable display is conducted with the left reel 21, the center reel 22 and the right reel 23 (S32), the second stage of variable display that again displays variably symbols having been displayed in a stationary mode in the left reel 21, the center reel 22 and the right reel 23 is conducted (S34). Therefore, it is possible to display symbols variably in a variety of variable mode that is visually fresh to the player and cannot be predicted by the player such that the variable display is not bound by the reel shape to display symbols variably or kinds of symbols associated with such reel. Therefore, the number of patterns of variation of the winning combination is increased and the expectation to the game by the player may be enhanced as well as a variety of games can be performed.

Also, since the reel that includes a symbol being displayed in a stationary mode at a position where a missing symbol constituting a winning combination is to be positioned if symbols are displayed in a reach combination of the winning combination is rotated, it is possible to display variably again the symbols having been displayed once in a stationary mode wherein the symbols almost include a winning combination such that a variety of effects may be performed so as not to bore the player.

Also, if the symbols do not include even a reach combination, all reels are rotated at the second stage of variable display such that all symbols being displayed in a stationary mode in a combination far from the winning combination are rotated again to be displayed variably so that the player may not be tired.

Further, since the variable direction of the symbols in the first stage of variable display is orthogonal to the variable direction of the symbols in the second stage of variable display, an effect of changing the variable directions may be maximized.

### Second Embodiment

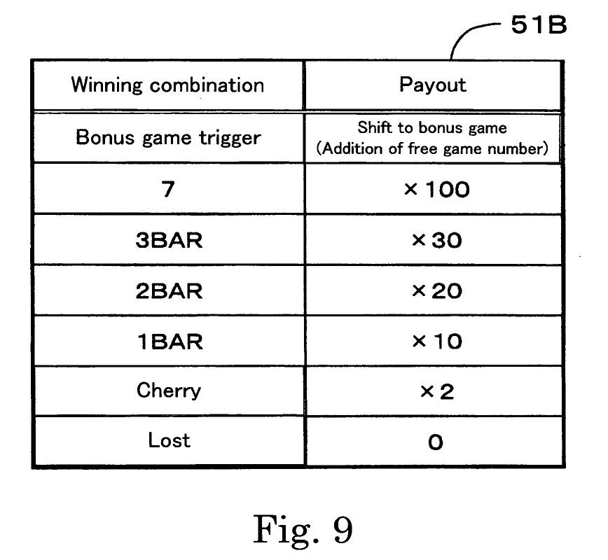

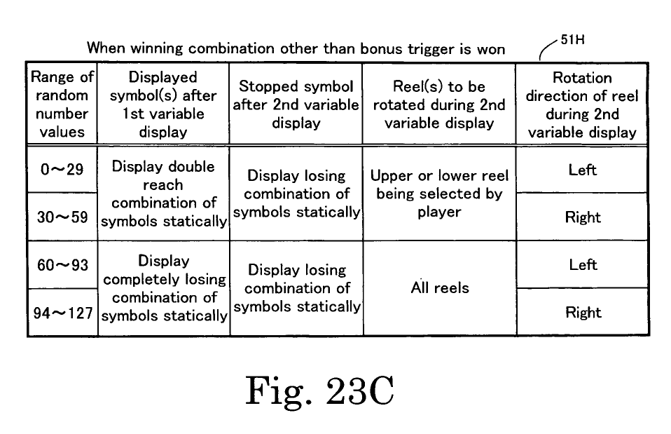

Next, according to a second embodiment, a slot machine is explained in reference to FIGS. 23 through 26. In the following explanation, the same configuration and the same references of the slot machine 1 of the first embodiment in FIGS. 1 through 22 as explained above will refer to the same configuration and the references of the slot machine 1 of the second embodiment.

The slot machine of the second embodiment is substantially the same as the slot machine of the first embodiment in a general configuration. Various control processes of the slot machine 1 of the first embodiment are substantially common with the slot machine of the second embodiment.

However, in the slot machine 1 of the first embodiment, a reel being selected from the top reel 24, the middle reel 25 and the bottom reel 26 beforehand based on the symbol effect lottery tables 51C through 51E is rotated while, in the slot machine of the second embodiment, the reel to be rotated is selected by the player when the second stage of variable display is conducted so as to rotate the reel selected by the player as opposed to the reel selected beforehand based on the symbol effect lottery tables in the first embodiment.

First, symbol effect lottery tables 51F through 51H to be utilized in selecting variable modes (or effect patterns) of symbols in the first and second stages of variable display in the S22 in reference to FIGS. 23A through 23C. FIGS. 23A through 23C show the symbol effect lottery tables for selecting variable modes of symbols in the base game in the slot machine of the second embodiment.

As shown in FIGS. 23A through 23C, the symbol effect lottery tables include three kinds of tables: a symbol effect lottery table 51F to be utilized if the bonus trigger is won in the lottery for the winning combination utilizing the winning combination lottery table 51A; a symbol effect lottery table 51G to be utilized if any winning combination other than the bonus trigger is won and a symbol effect lottery table 51H to be utilized if no winning combination is won (if it is lost). Also, the ranges of the random number values used in each symbol effect lottery table 51F through 51H are the same so that the common range is from 0 to 127.

Here, the symbol effect lottery table 51F to be utilized if the bonus trigger is won is identical to the symbol effect lottery table 51C of the first embodiment and the explanation thereof is omitted. Next, an explanation is made for the symbol effect lottery table 51G to be utilized if any winning combination other than the bonus trigger is won. The symbol effect lottery table 51G is identical to the symbol effect lottery table 51D of the first embodiment as long as the random number values sampled via the random number sampling circuit 56 range from 0 through 9 and 98 through 127.

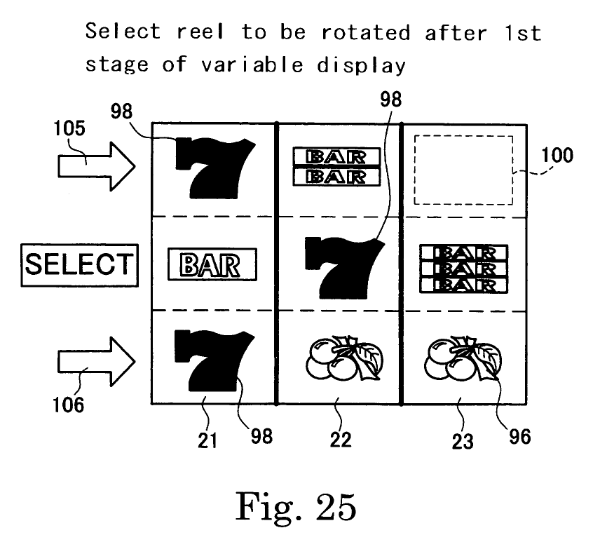

Further, if the random number value is in the range from 10 to 53, the following effect pattern is selected. A combination of symbols as shown in FIG. 25 (referred to as “double reach combination,” hereafter) where one symbol is missing from the winning combination along each of the cross-down line 7D and the cross-up line 7E at the same time are displayed once in a stationary mode in the left reel 21, the center reel 22 and the right reel 23 after the first stage of variable display. Then, the slot machine makes the player choose the top reel or the bottom reel such that the selected top reel 24 or bottom reel 26 is rotated from right to left and a symbol (referred to as “winning symbol,” hereafter) that constitutes the winning combination is displayed in a stationary mode at the position where the missing symbol used to be displayed.

Also, if the random number value is in the range from 54 to 97, the following effect pattern may be selected. The double reach combination is once displayed in a stationary mode in the left reel 21, the center reel 22 and the right reel 23 after the first stage of variable display. Then, the slot machine makes the player choose either top reel or bottom reel such that the selected top reel 24 or bottom reel 26 is rotated from left to right so as to display the winning combination in a stationary mode.

Further, an explanation is made for the symbol effect lottery table 51H to be utilized if no winning combination is won. If the random number value sampled via the random number sampling circuit 56 is in the range from 60 to 127, the symbol effect lottery table 51H is identical to the symbol effect lottery table 51E of the first embodiment.

Also, if the random number value is in the range from 0 to 29, the following effect pattern may be selected. The double reach combination of symbols are once displayed in a stationary mode in the left reel 21, the center reel 22 and the right reel 23 after the first stage of variable display. Then, the slot machine 1 makes the player choose either top reel or bottom reel such that the selected top reel 24 or bottom reel 26 is rotated from right to left so as to display a symbol other than the winning symbol in a stationary mode at the position where the missing symbol used to be displayed.

Also, if the random number value is in the range from 30 to 59, the following effect pattern may be selected. The double reach combination of symbols are once displayed in a stationary mode in the left reel 21, the center reel 22 and the right reel 23 after the first stage of variable display. Then, the slot machine 1 makes the player choose either top reel or bottom reel such that the selected top reel 24 or bottom reel 26 is rotated from left to right so as to display a symbol other than the winning symbol in a stationary mode at the position where the missing symbol used to be displayed.

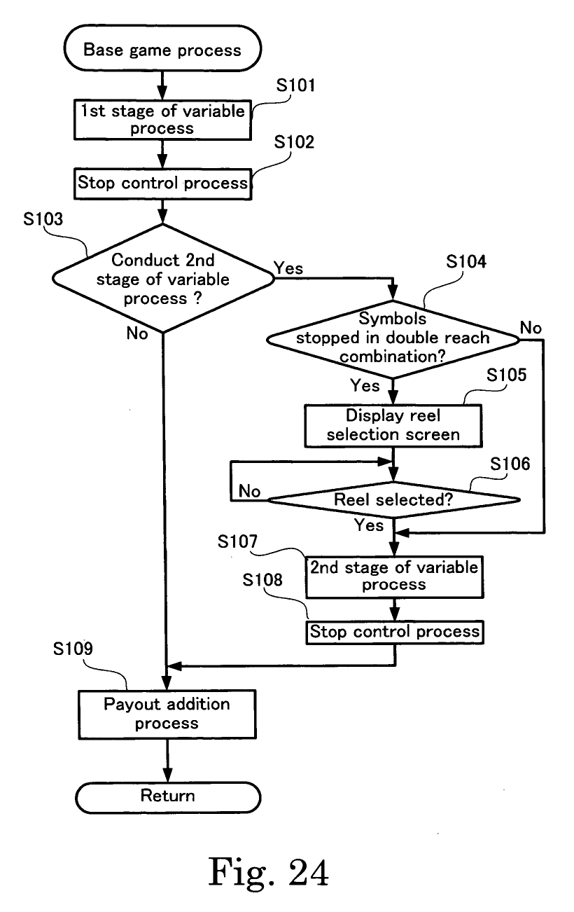

Next, an explanation is made in reference to FIG. 24 for the base game process program according to the second embodiment after the lottery process where the symbol effect lottery tables 51F through 51H shown in FIGS. 23A though 23C are utilized. FIG. 24 shows a flow chart of the base game process program in the slot machine according to the second embodiment.

Here, the processes in S101 through S103 are similar to the processes in the S31 through the S33 of the base game process of the first embodiment such that an explanation thereof is omitted.

In S104, it is determined whether a double reach combination of symbols are displayed in a stationary mode in the stationary display areas 211 through 213, 221 through 223 and 231 through 233 after the first stage of variable display or not. More specifically, if a winning combination other than the bonus trigger is won in the winning combination lottery process in the S21 and the random number value sampled in the symbol effect lottery process in the S22 is in the range form 10 through 97, or if it is lost in the winning combination lottery process in the S21 and the random number value sampled in the symbol effect lottery process in the S22 is in the range form 0 through 59, it is determined that the double reach combination of symbols are displayed in a stationary mode.

Then, if it is determined that the double reach combination of symbols are not displayed in a stationary mode (S104: NO), the second stage of variable display in the top reel 24, the middle reel 25 and the bottom reel 26 is conducted subsequent to the first stage of variable display (S107) and respective symbols are displayed in a stationary mode (S108).

On the other hand, if it is determined that the double-reach combination of symbols are displayed in a stationary mode (S104: YES), a reel selection screen (refer to FIG. 25) to let the player choose either top reel 24 or bottom reel 26 is displayed on the lower liquid crystal display 4 (S105).

Subsequently, in S106, it is determined whether either reel is selected by the player or not based on the operation information from the touch panel 121. Then, if it is determined that the reel is not selected (S106: NO), the program will wait until the reel is selected. On the other hand, if it is determined that the reel is selected (S106: YES), the program proceeds to S107 and the second stage of variable display is conducted in the top reel 24, the middle reel 25 and the bottom reel 26 (S107) and respective symbols are displayed in a stationary mode (S108).

In the following, an explanation is made for the variable modes of symbols being accompanied with the reel selection in the second stage of variable display with an example.

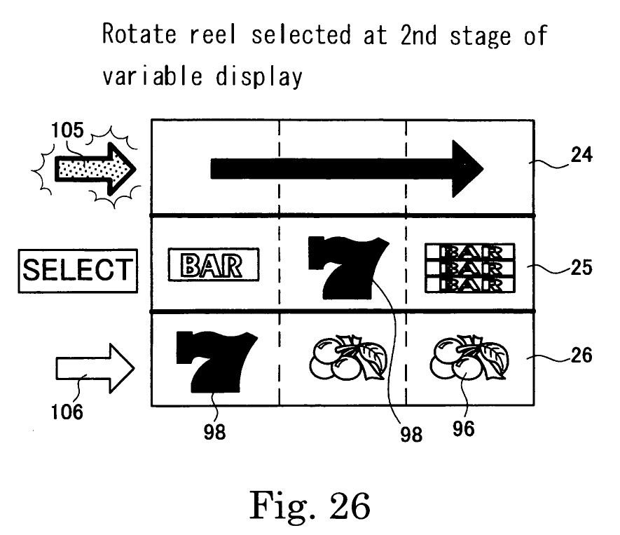

For example, an explanation is made for a case where the SEVEN (7) winning combination, which is other than the bonus trigger, is won in the winning combination lottery process in the S21 and the random number value sampled in the symbol effect lottery process in the S22 is in the range form 54 through 97. First, a double-reach combination of symbols are displayed in a stationary mode such that the SEVEN (7) symbols 98 are almost aligned along the cross-down line 7D and the cross-up line 7E as shown in FIG. 25 after the first stage of variable display. Then, the lower liquid crystal display 4 shows a reel selection screen where reel selection parts 105, 106 are newly displayed on the left side of the left reel 21. Then, if the reel selection part 105 is selected by the player via the touch panel 121, only the top reel 24 is newly rotated from left to right in the second stage of variable display as shown in FIG. 26 wherein a blank symbol 100, which is the losing symbol, belongs to the top reel 24. Then, the SEVEN (7) symbol 98 is displayed in a stationary mode in the seventh stationary display area 231 so as to complete the SEVEN (7) winning combination.

Further, if the reel selection part 106 is selected by the player via the touch panel 121, only the bottom reel 26 where the cherry symbol 96 as the losing symbol belongs is rotated from left to right. Then the SEVEN (7) symbol is displayed in a stationary mode in the ninth stationary display area so as to complete the SEVEN (7) winning combination.

Subsequently, a payout amount determined based on the payout table 51B in FIG. 9 is stored in accordance with the winning combination displayed in a stationary mode in S109 after the second stage of variable display. The stored payout amount is paid out together with the payout amount of the bonus game in the payout process in the S6 if the bonus game is conducted.

Then, the program returns to the main process program after the payout addition process and proceeds to the determination process in S4.

As explained above, in the slot machine of the second embodiment, if a double-reach combination of symbols are displayed in a stationary mode in the left reel 21, the center reel 22 and the right reel 23 after the first stage of variable display is conducted in the left reel 21, the center reel 22 and the right reel 23 in the base game (S101), the reel selection screen is displayed (S105) so as to make the player choose the reel to be rotated in the second stage of variable display. Then, the second stage of variable display is conducted (S107) such that symbols are moved again from left to right in the selected reel. Therefore, it is possible to display symbols variably in a variety of variable mode that is visually fresh to the player and cannot be predicted by the player such that the variable display is not bound by the reel shape to display symbols variably or kinds of symbols associated with such reel. Further, the player himself can select the reel to be rotated such that he might have a feeling of higher accomplishment toward the game than usual after the winning combination is completed.

Here, it should be understood that the present invention is not limited to the above-described embodiment, but may be improved or modified without departing from the spirit and range of the present invention.

For example, in the slot machine of the first and the second embodiments, the second stage of variable display is not conducted if the winning combination is displayed in a stationary mode after the first stage of variable display. However, the second stage of variable display may be conducted subsequent to the first stage of variable display even though the winning combination is displayed in a stationary mode after the firs stage of variable display.

Also, in the slot machine of the first and the second embodiments, the second stage of variable display is conducted in the top reel 24, the middle reel and the bottom reel 26 only in the base game. The second stage of variable display may be conducted in a free game, i.e., the bonus game.

Further, in the slot machine of the first and the second embodiments, a lottery style of selecting the winning combination is employed based on the random number value sampled in the lottery process in S2. However, the following style may be employed. Each code number is assigned to each symbol such that the lottery style for conducting a lottery to select the kind of symbol stopped on the center line 7A.

Further, in the slot machine of the first and the second embodiments, the lottery for selecting the winning combination based on the winning combination lottery table 51A and the lottery for selecting effect patterns of variable display based on the symbol effect lottery tables 51C to 51E or the symbol effect lottery tables 51F through 51H are conducted separately with different tables. However, one table defining the winning combinations and the effect patterns in association with each other so as to conduct the lottery at the same time.

Also, in the slot machine of the first and the second embodiments, nine symbols having been displayed in a stationary mode after the first stage of variable display are divided into the fourth group through the sixth group, and the symbols are displayed variably from left to right in the second stage of variable display. It is OK to add more and/or different kinds of symbols other than the nine symbols displayed in a stationary mode such that the variable display may be made with such added symbols.

Also, in the slot machine of the first and the second embodiments, the rotation directions of the top reel 24, the middle reel 25 and the bottom reel 26 are the same so as to be in right direction or in left direction. However, when two or more reels are rotated, the rotation directions may include both right and left directions to form a mixture.

Also, in the slot machine of the first and second embodiments, the video reel of 3×3 (three times three) is used for explanation. The reel configuration is, however, not limited to this, but by way of example, the 3×5 video reel can be used. In such a case, in the first stage of variable embodiment, the five columns of reels are rotated in the first variable display.

In addition to the aforementioned embodiments, the present invention may include the following examples.

There is provided a gaming machine comprising: first variable display means (e.g., the left reel 21, the center reel 22 and the right reel 23) for displaying variably a plurality of symbols, which are divided into groups of symbols of a first kind (e.g., the first group of symbols 92, the second group of symbols 93 and the third group of symbols 94) such that each group of symbols are moved in a first direction (e.g., from top to bottom); first stop control means (e.g., CPU 50, S32) for controlling the first variable display means to display in a stationary mode a first stationary combination of symbols; first award means (e.g., CPU 50, S36) for awarding a benefit to a player based on a predetermined winning combination when the first stationary combination of symbols includes the predetermined winning combination; second variable display means (e.g., the top reel 24, the middle reel 25 and the bottom reel 26) for displaying variably in a second direction (e.g., from right to left) a predetermined number of symbols out of the first stationary combination of symbols, which are at least partially divided into one or more groups of symbols of a second kind (e.g., the fourth group, the fifth group and the sixth group); second stop control means (e.g., CPU 50, S35) for controlling the second variable display means to display in a stationary mode a second stationary combination of symbols; and second award means (e.g., CPU 50, S36) for awarding a benefit to the player based on the predetermined winning combination when the second stationary combination includes the predetermined winning combination.

Here, the “winning combination” is a combination of symbols disclosed with the payout rate to the player by the panel or the like and is generally composed of more than a predetermined number of symbols of the same kind being displayed in a stationary mode along the activated pay line.

Also, the “first group differing from the second group” may be explained as follows. For example, if a plurality of symbols displayed next to next are grouped as the first group by one direction (e.g., from top to the bottom). Then, the second group is composed of neighboring symbols along a different direction (e.g., from left to right).

Also, to award a benefit may include to pay out game media such as credits and to enable the bonus game to be played.

Also, the “second direction,” is not necessarily composed of a single direction, but may also include a plurality of directions as a mixture. For example, more than one group is included in the second group and a plurality of symbols are displayed variably such that the plurality of symbols may be shown in respective directions for each group among the second group.

Also in the aforementioned gaming machine (e.g., slot machine 1), when the first stop control means (e.g., CPU, S32) controls the first variable display means (e.g., the left reel 21, the center reel 22, and the right reel 23) to display the first stationary combination including a reach combination missing only one symbol from the predetermined winning combination, the second variable display means (e.g., the top reel 24, the middle reel 25 and the bottom reel 26) displays variably in the second direction the predetermined number of symbols which include the one symbol.

Also, in the aforementioned gaming machine (e.g., slot machine 1), the second stop control means (e.g., CPU 50, S35) controls the second variable display means (e.g., the top reel 24, the middle reel 25 and the bottom reel 26) to display a second stationary combination including the predetermined winning combination by utilizing the reach combination when a predetermined condition is satisfied.

Also, in the aforementioned gaming machine (e.g., slot machine 1), the second stop control means (e.g., CPU 50, S32) causes the second variable display means displays (e.g., the top reel 24, the middle reel 25 and the bottom reel 26) variably all symbols of the first stationary combination of symbols in the second direction in the first variable display means (e.g., the left reel 21, the center reel 22 and the right reel 23) when the first stationary combination includes neither the predetermined winning combination nor the reach combination.

Also, in the aforementioned gaming machine (e.g., slot machine 1), the gaming machine further comprises: group selection means (e.g., touch panel 121) for making a selection from the one or more groups of symbols of the second kind, wherein the second variable display means (e.g., CPU 50, S35) displays variably the predetermined number of symbols based on the selection.

Here, the “group selection means” may be a means for selecting the second group based on the player's operation as described in the second embodiment, or a means for selecting the second group based on the internal lottery being conducted inside the gaming machine as described in the first embodiment.

Also, in the aforementioned gaming machine (e.g., slot machine 1), the first direction is orthogonal to the second direction.

In the gaming machine, a plurality of symbols being displayed in a stationary mode in the first variable display means of each column by the first stop control means are grouped into the second group, which is different from the first group, and at least one group of symbols in the second group are displayed variably in the second direction. Therefore, it is possible to display symbols variably in a variety of variable mode that is visually fresh to the player and cannot be predicted by the player such that the variable display is not bound by the reel shape to display symbols variably or kinds of symbols associated with such reel. Thus, more variations of the winning combinations are obtained such that the expectation by the player may be enhanced and a variety of game can be performed.

Also, in the gaming machine, if the symbols displayed in a stationary mode on each column of the first variable display means by the first stop control means include a combination that lacks in only one symbol to complete a predetermined winning combination, symbols in the second group are displayed variably in the second direction, the symbols including a symbol being displayed in a position where a missing symbol is to be placed to complete the winning combination. Therefore, it is possible to perform a variety of effect such that the symbols displayed in a stationary mode in a combination close to the winning combination are displayed variably again in the second direction so as not to bore the player.

Also, in the gaming machine, the second variable display means is controlled to come to a halt such that the winning combination is completed with the combination lacking in only one symbol if a predetermined winning combination is satisfied. The symbols having been displayed in a stationary mode in a combination close to the winning combination can be displayed variably again and the complete winning combination is displayed in a stationary mode so as to perform a variety of effect and not to bore the player.

Also, in the gaming machine, if the symbols displayed in a stationary mode in each column of the first variable display means do not include any winning combinations or any combination that lacks in only one symbol from the winning combinations, the symbols grouped in the second group are displayed variably in the second direction such that a combination of symbols far from the winning combination are all displayed variably so as to perform a variety of effect and not to bore the player.

Also, in the gaming machine, a group of symbols selected from the second group are displayed variably and the player may have a feeling of higher achievement than usual if better result is obtained.

Further, in the gaming machine, the first and the second directions are substantially perpendicular such that the effect by changing the variable directions may be highest.

What is claimed is:

1. A gaming machine comprising:
a display device for displaying a plurality of symbols in a variable mode and a stationary mode; and
a control device for controlling the display device,
wherein the plurality of symbols are divided into groups of symbols of a first kind and each group of symbols of the first kind are moved in a first direction;
wherein the control device controls the display device to display in a stationary mode a first stationary combination of symbols;
wherein a benefit is awarded based on a predetermined winning combination when the first stationary combination of symbols includes the predetermined winning combination;
wherein a predetermined number of symbols out of the first stationary combination of symbols are at least partially divided into one or more groups of symbols of a second kind and the control device controls the display device to display variably the predetermined number of symbols in a second direction;
wherein the control device controls the display device to display in a stationary mode a second stationary combination of symbols; and
wherein a benefit is awarded based on a predetermined winning combination to be included in the first stationary combination or based on the predetermined winning combination when the second stationary combination of symbols includes the predetermined winning combination.

2. The gaming machine according to claim 1, wherein, after the display device displays the first stationary combination including a reach combination missing only one symbol from the predetermined winning combination, the control device controls the display device to display variably in the second direction the predetermined number of symbols which include the one symbol.

3. The gaming machine according to claim 2, wherein the control device controls the display device to display a second stationary combination including the predetermined winning combination by utilizing the reach combination when a predetermined condition is satisfied.

4. The gaming machine according to claim 1, wherein the control device controls the display device to display variably all symbols of the first stationary combination of symbols in the second direction when the first stationary combination includes neither the predetermined winning combination nor the reach combination.

5. The gaming machine according to claim 1, wherein the control device controls the display device to display a screen for urging the player to make a selection from the one or more groups of symbols of the second kind such that the predetermined number of symbols are variably displayed based on the selection.

6. The gaming machine according to claim 1, wherein the control device controls the display device to display variably a first symbol and a second symbol that belong to the predetermined number of symbols, the first symbol having been displayed at a first place where the second symbol is required in order to complete the predetermined winning combination in the first stationary combination.

7. A gaming machine comprising:
a display device for displaying a plurality of symbols in a variable mode and a stationary mode; and
a control device for controlling the display device,
wherein the display device comprises a plurality of display areas where the plurality of symbols are displayed;
wherein the plurality of display areas are divided into groups of a first kind and groups of a second kind in an overlapping manner, the groups of the first kind being aligned with each other along a first direction, the groups of the second kind being aligned with each other along a second direction;
wherein the control device controls the display device to display the plurality of symbols variably in the respective groups of display areas of the first kind such that the symbols are moved in a first direction within each group of display areas of the first kind during a first variable display and the control device controls the display device to display a first stationary combination in a stationary mode after the first variable display;
wherein the control device controls the display device to display variably at least one of the symbols out of the first stationary combination within one or more respective groups out of the groups of display areas of the second kind such that the at least one of the symbols is moved in the second direction within the one or more respective groups of the second kind during a second variable display and the control device controls the display device to display a second stationary combination in a stationary mode after the second variable display; and
wherein a benefit is awarded based on a predetermined winning combination to be included in the first stationary combination or based on the predetermined winning combination to be included in the second stationary combination.

8. The gaming machine according to claim 7, wherein, when the control device controls the display device to display the first stationary combination including a reach combination missing only one symbol from the predetermined winning combination, the control device controls the display device to display variably in the second direction the at least one of the symbols which includes the one symbol.

9. The gaming machine according to claim 8, wherein the control device controls the display device to display a second stationary combination including the predetermined winning combination by utilizing the reach combination when a predetermined condition is satisfied.

10. The gaming machine according to claim 7, wherein the control device controls the display device to display variably all symbols out of the first stationary combination within the one or more respective groups when the first stationary combination includes neither the predetermined winning combination nor the reach combination.

11. The gaming machine according to claim 7, wherein the control device controls the display device to show a selection screen to urge a player to make a selection from the one or more groups of display areas of the second kind.

12. The gaming machine according to claim 11, wherein the control device controls the display device to display the at least one of the symbols variably within the one or more respective groups based on the selection.

13. The gaming machine according to claim 7, wherein the control device controls the display device to display variably a first symbol and a second symbol to be moved within the one group of the second kind, the first symbol having been displayed at a first place where the second symbol is required in order to complete the predetermined winning combination in the first stationary combination.

14. The gaming machine according to claim 1, wherein the first direction is orthogonal to the second direction.

15. The gaming machine according to claim 7, wherein the first direction is orthogonal to the second direction.
